(19) United States
(12) Patent Application Publication
(10) Pub. No.: US 2017/0315699 A1
(43) Pub. Date: Nov. 2, 2017

(54) NOVEL SYSTEM FOR CAPTURE, TRANSMISSION, AND ANALYSIS OF EMOTIONS, PERCEPTIONS, AND SENTIMENTS WITH REAL-TIME RESPONSES

(71) Applicant: EMOJOT, MOUNTAIN VIEW, CA (US)

(72) Inventors: Shahani Markus, Mountain View, CA (US); Manjula Dissanayake, Netherby (AU); Sachintha Rajith Ponnamperuma, Batuwanhena (SR); Andun Sameera Liyanagunawardana, Weligama (SR)

(73) Assignee: EMOJOT, MOUNTAIN VIEW, CA (US)

(21) Appl. No.: 15/242,125

(22) Filed: Aug. 19, 2016

Related U.S. Application Data
(63) Continuation of application No. 15/141,833, filed on Apr. 29, 2016, now abandoned.

(51) Int. Cl. G06F 3/0481; G06Q 30/00; G06Q 30/02; G06Q 50/00; G06F 3/0482; H04N 21/858; G06K 9/00; H04N 5/232; H04N 21/431

(52) U.S. Cl. CPC G06F 3/04817; G06Q 50/01; G06Q 30/016; G06Q 30/0269; G06F 3/0482; G06K 9/00362; H04N 5/232; H04N 21/4312; H04N 21/8586

(57) ABSTRACT

The present disclosure relates to a sophisticated system and method of transmitting and receiving emotes of individual feelings, emotions, and perceptions with the ability to respond back in real time. The system includes receiving an emote transmission. The emote expresses a present idea or a present emotion in relation to a context. The emote transmission is enacted in response to the context. The system further includes receiving a plurality of emote transmissions in relation to a context during a first time period wherein the plurality of emote transmissions express at least one of a plurality of expected outcomes related to the context. The system includes a kiosk which comprises a camera, a display which comprises a user interface having one or more emotives that indicate one or more present ideas or present emotions, and a non-transitory storage readable storage medium comprising a back-end context recognition system.

### CROSS-REFERENCE TO RELATED APPLICATION

This application claims the benefit of and is a continuation-in-part to U.S. Non-Provisional application Ser. No. 15/141,833 entitled “A Generic Software-Based Perception Recorder, Visualizer, and Emotions Data Analyzer” filed Apr. 29, 2016.

### FIELD OF THE DISCLOSURE

The present disclosure relates to a sophisticated system and method of transmitting and receiving emotes of individual feelings, emotions, and perceptions with the ability to respond back in real time.

### BRIEF DESCRIPTION OF THE DRAWINGS

To facilitate understanding, identical reference numerals have been used, wherever possible, to designate identical elements that are common to the figures. The drawings are not to scale and the relative dimensions of various elements in the drawings are depicted schematically and not necessarily to scale. The techniques of the present disclosure may readily be understood by considering the following detailed description in conjunction with the accompanying drawings, in which:

FIG. 1 is an illustration of a solutions platform for a system consistent with the present disclosure;

FIG. 2 is an illustration of a solutions platform's server-side process;

FIG. 3 is an illustration of a solutions platform's client-side process;

FIG. 4 is a flowchart for a method of creating, publishing, and responding to emotion sensors;

FIG. 5 is an exemplary computing device which displays an interface for selecting emotives;

FIG. 6 is an illustration of a dashboard which displays emolytics;

FIG. 7 is an illustration of a use case for employing emotion sensors during a live presentation;

FIG. 8 is an illustration of another use case for employing emotion sensors for viewer's while watching a television show;

FIG. 9 is an illustration of yet another use case for employing emotion sensors within a customer service environment;

FIG. 10 is an illustration of an exemplary emotion sensor with an embedded video;

FIG. 11 is an illustration of another emotion sensor consistent with the present disclosure;

FIG. 12 is an illustration of yet another emotion sensor consistent with the present disclosure;

FIG. 13 is an illustration of a video emotion sensor;

FIG. 14 is an illustration of a standard emotion sensor which features a geographical map displaying a geographical distribution of emotes related to a context;

FIG. 15 is an illustration of a standard emotion sensor which features an emote pulse related to a context;

FIG. 16 is an illustration of a social media feed feature related to a context;

FIG. 17 is an illustration of a text feedback feature related to a context;

FIG. 18 is an illustration of an image emotion sensor related to a context;

FIG. 19 is an illustration of an email emotion sensor related to a context;

FIG. 20 is a flowchart for a method of computing influence scores;

FIG. 21 is a flowchart for a method of tallying the number of unique individuals that use an emote system within a customer service environment;

FIG. 22 is a flowchart for a method of correlating social media data with emotion data related to a context;

FIG. 23 is a flowchart for a method of computing a confidence metric assigned to emotion data related to a context;

FIG. 24 is an exemplary kiosk system for which users can emote with respect to a given context;

FIG. 25 is an exemplary webpage with a web-embedded emotional sensor;

FIGS. 26A and 26B are illustrations of one embodiment of an emoji burst;

FIGS. 27A and 27B are illustrations of another embodiment of an emoji burst;

FIGS. 28A and 28B are illustrations of yet another embodiment of an emoji burst;

FIG. 29 is an illustration of an alternative layout for an emoji burst displayed on a tablet device; and

FIG. 30 is an illustration of a graphical user interface for a video sensor related to a context and a playlist of video sensors related to the context.

### DETAILED DESCRIPTION

Before the present disclosure is described in detail, it is to be understood that, unless otherwise indicated, this disclosure is not limited to specific procedures or articles, whether described or not.

It is further to be understood that the terminology used herein is for the purpose of describing particular embodiments only and is not intended to limit the scope of the present disclosure.

It must be noted that as used herein and in the claims, the singular forms “a,” and “the” include plural referents unless the context clearly dictates otherwise. Thus, for example, reference to “an emotive” may also include two or more emotives, and so forth.

Where a range of values is provided, it is understood that each intervening value, to the tenth of the unit of the lower limit unless the context clearly dictates otherwise, between the upper and lower limit of that range, and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also included in the disclosure. The term “about” generally refers to ±10% of a stated value.

The present disclosure relates to a sophisticated system and method for capture, transmission, and analysis of emotions, sentiments, and perceptions with real-time responses. For example, the present disclosure provides a system for receiving emote transmissions (e.g., of user-selected emotes). In one or more implementations, each emotive expresses a present idea or present emotion in relation to a context. The emote may be in response to sensing a segment related to the context. Further, transmitting a response (e.g., to the user) in response to receiving an emote transmission. The response may be chosen based on the emote transmissions.

The present disclosure also provides a system for receiving a first plurality of emote transmissions during an event or playback of a recorded video of the event during a first time period. Additionally, receiving a second plurality of emote transmissions during the event or the playback of the recorded video of the event during a second time period. The first and the second plurality of emote transmissions express various present ideas or present emotions of the user. In one implementation, the second time period is later in time than the first time period. Next, computing a score based on a change from the first plurality of emote transmissions to the second plurality of emote transmissions.

Advantageously, the present disclosure provides an emotion sensor which may be easily customized to fit the needs of a specific situation and may be instantly made available to participants as an activity-specific perception recorder via the mechanisms described herein. Furthermore, the present disclosure supports capturing feelings or perceptions in an unobtrusive manner with a simple touch/selection of an icon (e.g., selectable emotive, emoticon, etc.) that universally relates to an identifiable emotion/feeling/perception. Advantageously, the present disclosure employs emojis and other universally-recognizable expressions to accurately capture a person's expressed feelings or perceptions regardless of language barriers or cultural and ethnic identities. Moreover, the present disclosure allows continuously capturing moment-by-moment emotes related to a context.

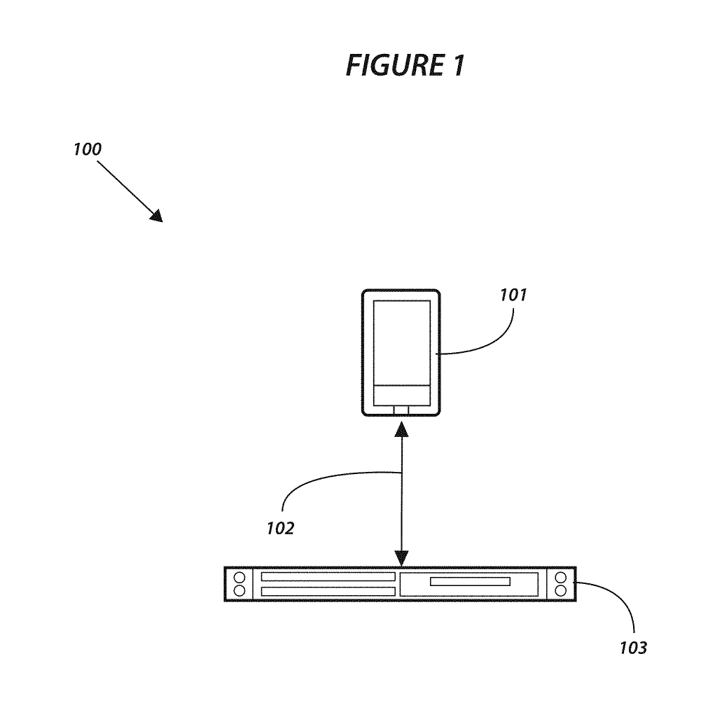

FIG. 1 is an illustration of a solutions platform 100 for a system consistent with the present disclosure. Solutions platform 100 may include a client 101 such as a smartphone or other computing device 101. Utilizing the client 101 allows a user to transmit an emotive to effect emoting to a server-side computational and storage device (e.g., server 103) to enable crowd-sourced perception visualization and in-depth perception analysis. In some embodiments of the present disclosure, emotives are selectable icons which represent an emotion, perception, sentiment, or feeling which a user may experience in response to a context.

Moreover, the emotives may be dynamically displayed such that they change, according to the publisher's setting, throughout the transmission of media. For instance, a new emote palette may dynamically change from one palette to another palette at a pre-defined time period. Alternatively, an emote palette may change on demand based on an occurrence during a live event (e.g., touchdown during a football game).

In one or more embodiments of the present disclosure, an emote represents a single touch or click of an icon (e.g., emotive) in response to some stimulus. In some implementations, an emote contains contextual information (e.g., metadata user information, location data, transmission data-time/date stamps).

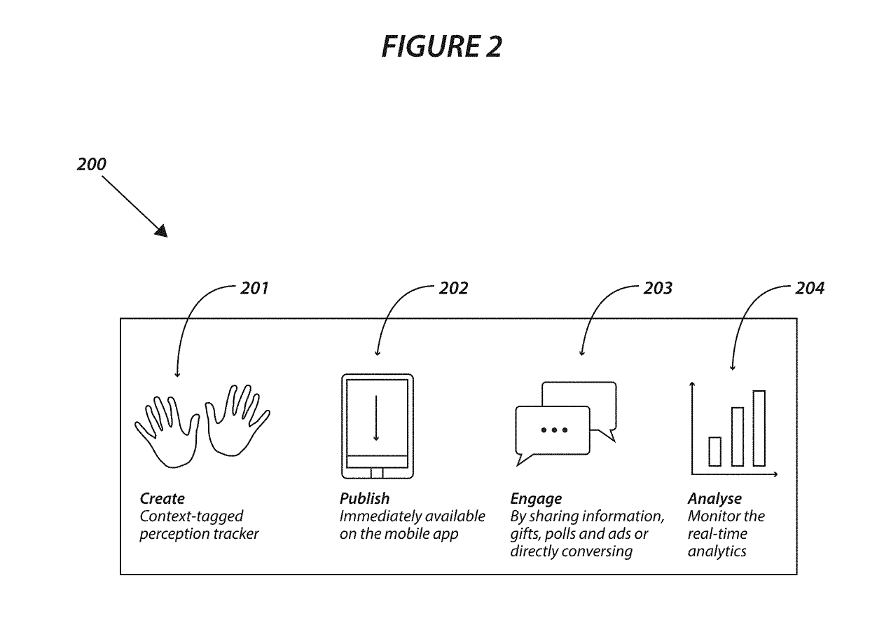

FIG. 2 is an illustration of a solutions platform's server-side process. The (3-step) process begins with block 201 when a publisher creates a context-tagged perception tracker (201) (i.e., emotion sensor). A publisher may create one or more emotion sensors to gauge emotions, feelings, or perceptions related to a specific context. The emotion sensor may represent a situation-specific perception recorder to suit publisher's context requirements. In some embodiments, a publisher may also be referred to as an orchestrator.

The present disclosure provides a variety of emotion sensors such as, but not limited to, a standard emotion sensor, a video emotion sensor, a web-embedded emotion sensor, an image emotion senor, or an email emotion sensor as will be described therein. It should be understood, however, that the present disclosure is not limited to the types of emotion sensors previously listed. Emotion sensors may be employed or embedded within any suitable medium such that users can respond to the context-tagged perception tracker.

When creating an emotion sensor (201), a publisher may set up an activity such as an event or campaign. For example, a movie studio may create situation-specific emotives to gauge the feelings, emotions, perceptions, or the like from an audience during a movie, television show, or live broadcast.

In one or more embodiments, a publisher may set up the emotion sensor such that pre-defined messages are transmitted to users (i.e., emoters) based on their emotes. For instance, a publisher can send messages (e.g., reach back feature) such as ads, prompts, etc. to users when they emote at a certain time, time period, or frequency. In alternative embodiments, the messages may be one of an image, emoji, video, or URL. Messages may be transmitted to these users in a manner provided by the emoters (e.g., via registered user's contact information) or by any other suitable means.

Moreover, messages may be transmitted to users based on their emotes in relation to an emote profile of other emoters related to the context. For example, if a user's emotes are consistent, for a sustained period of time, to the emotes or emote profiles of average users related to a context, a prize, poll, or advertisement (e.g., related to the context) may be sent to the emoter. Contrariwise, if the user's emotes are inconsistent with the emotes or emote profiles of average users related to the context (for a sustained period of time), a different prize, poll, or advertisement may be sent to the user.

The emotion sensor may be published (202) immediately after it is created. After the emotion sensor is published, it may be immediately accessible to a smartphone device (203). Once users emote, they may be further engaged by sharing information or sending a prize, advertisement, etc. back to the users

The emote data can be analyzed (204). As such, this stage may allow publishers (or other authorized personnel) the ability to monitor emotion analytics (i.e., emolytics) real-time. In some implementations, publishers may access emolytic information related to a context on a designated dashboard.

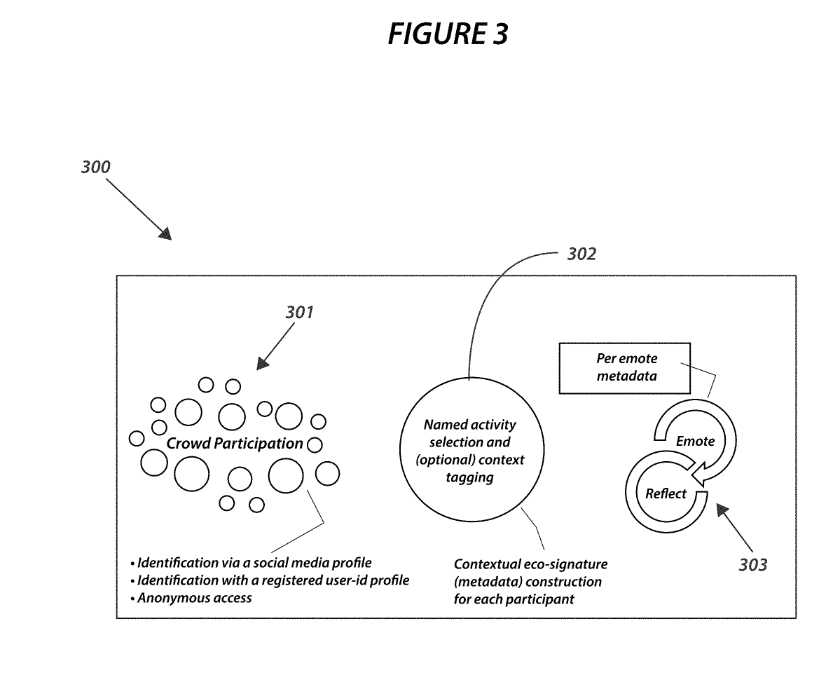

FIG. 3 is a schematic layout 300 illustration of a solutions platform's client-side process. Schematic layout 300 illustrates a manner in which one or more participants (e.g., emoters) can continuously record their individual emotions/perceptions/feelings such that real-time visualization and meaningful analysis of perceptions are enabled.

The use of crowd participation (301) may be used to gauge a crowd's response to an activity or event. Users, in some implementations, may choose to identify themselves. For example, users may identify themselves via a social media profile or with a registered user-id profile. Alternatively, users may choose to emote anonymously.

On a client side, an emoter is able to access their emoting history and a timeline series of their emotes against an average of all emotes in a contextual scenario. The activity or event may be named (e.g., context tag) and contextual eco-signature (metadata) construction for each participant may be obtained. Moreover, metadata may be obtained (303) for each emote.

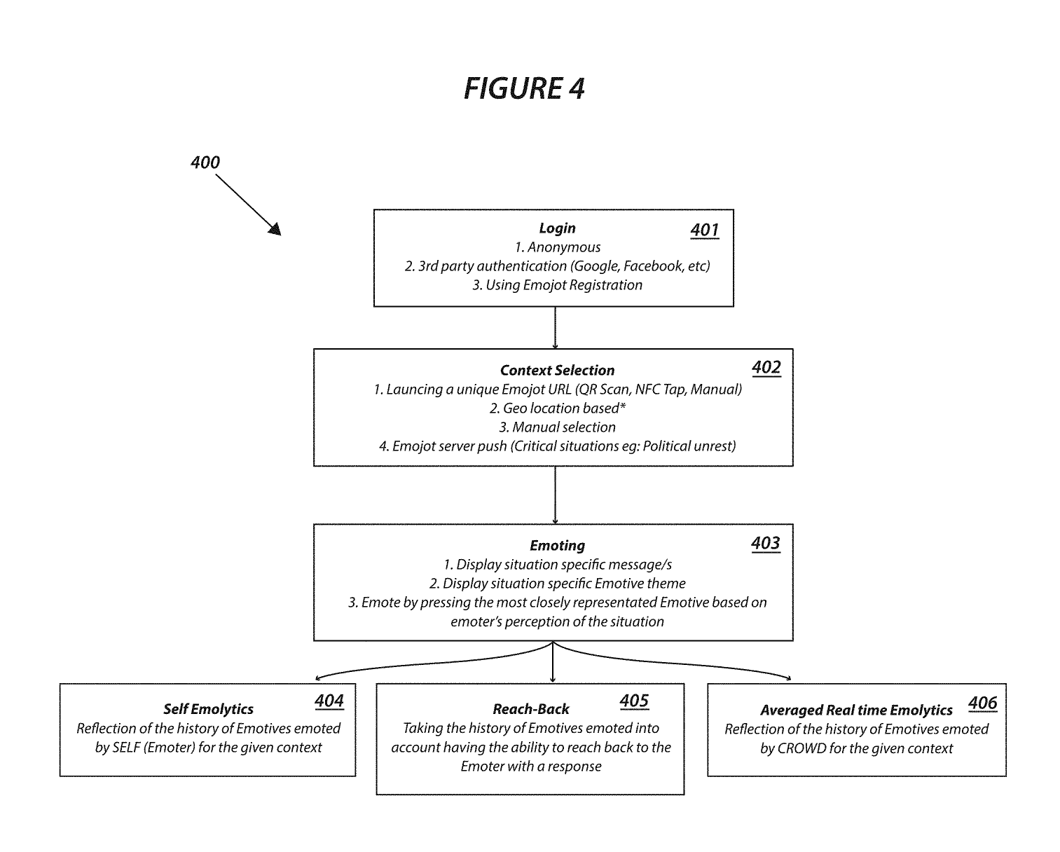

FIG. 4 is a flowchart 400 for a method of creating, publishing, and responding to emotion sensors. Flowchart 400 begins with block 401—user login. Upon logging in, a user can identify themselves or do so anonymously. For example, a user may log in via a third-party authentication tool (e.g., via a social media account) or by using a proprietary registration tool.

Block 402 provides context selection by any of various manners. For example, context selection may be geo-location based, and in other embodiments, context selection is accomplished via manual selection. In yet other embodiments, context selection is accomplished via a server push. For example, in the event of a national security emergency (e.g., a riot), a server push of an emotion sensor related to the natural security emergency may be accomplished.

Block 403—emoting. Emoting may be in response to a display of emotive themes which represent the emoter's perception of the context. Block 404—self emolytics. An emoter may check their history of emotes related to a context. Block 405—reach back. The present disclosure may employ a system server to perform reach back to emoters (e.g., messages, prizes, or advertisements) based on various criteria, triggers, or emoters' emote histories. Block 406—average real time emolytics. Users may review the history of emotes by other users related to a given context.

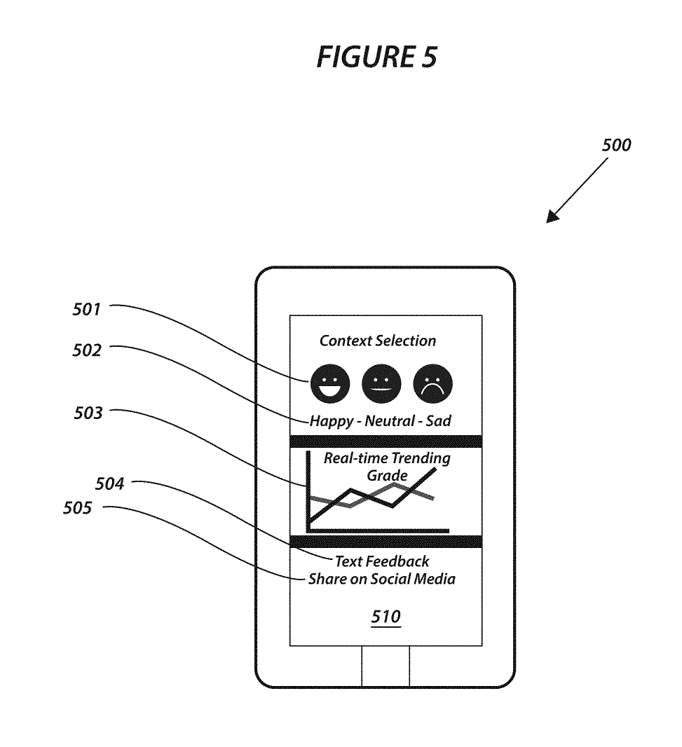

FIG. 5 is an exemplary computing device 500 which displays an interface 510 for selecting emotives. Interface 510 features three emotives for a context. A context may represent a scenario such as an event, campaign, television program, movie, broadcast, or the like.

Context-specific emotive themes (e.g., human emotions—happy, neutral, or sad) are displayed on the interface 510. In some embodiments, the context-specific themes 501 may be referred to as an emotive scheme (e.g., emoji scheme). An emotive scheme may be presented as an emoji palette from which a user can choose to emote their feelings, emotions, perceptions, etc.

For example, an emotive theme for an opinion poll activity may have emotives representing “Agree”, “Neutral”, and “Disagree.” Alternatively, an emotive theme for a service feedback campaign activity may include emotives which represent “Satisfied,” “OK,” and “Disappointed.”

A label 502 of each emotive may also be displayed on the interface 510. The description text may consist of a word or a few words that provide contextual meaning for the emotive. In FIG. 5, the words “Happy,” “Neutral,”, and “Sad” appear below the three emotives in the contextual emotive theme displayed.

Interface 510 further displays real-time emolytics. Emolytics 510 may be ascertained from a line graph 503 that is self or crowd-averaged. When the self-averaged results are selected, the averaged results of the emotes for a contextual activity are displayed. Alternatively, when the crowd-averaged results are selected, the average overall results of all emotes are displayed.

Next, interface 510 enables text-based feedback 504. In some embodiments, the text-based feedback 504 is a server configurable option. Similar to Twitter® or Facebook®, if text input is supported for a certain contextual activity, the text-based feedback option allows for it.

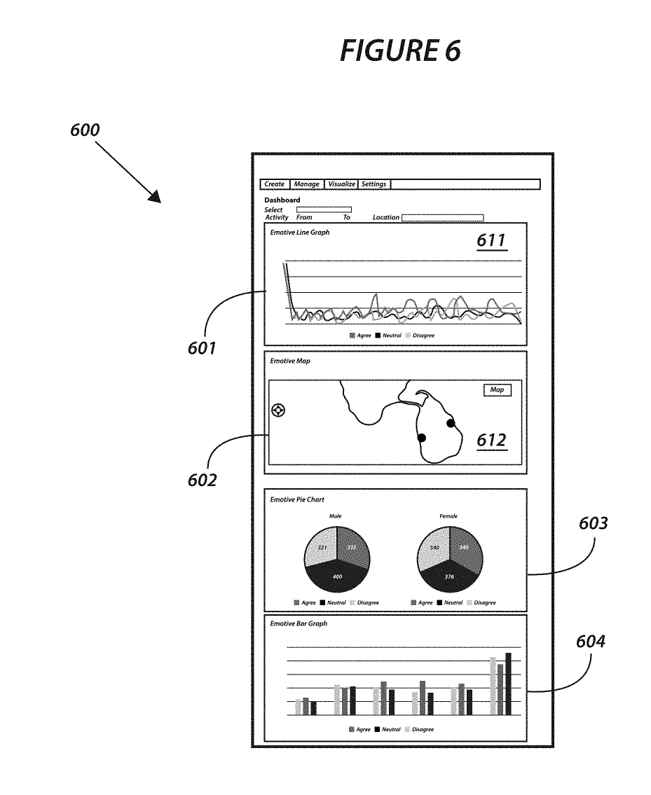

FIG. 6 is an illustration of a dashboard 600 which displays emolytics related to a context. Dashboard 600 may be accessible to a publisher. Dashboard 600 may provide emolytics for several context selections. Advantageously, emolytics data may be generated and analyzed to determine which stimuli, related to a context, induces specific emotions, feelings, or perspectives.

Dashboard 600 may have a plurality of sections which display emolytics. For example, section 601 includes a line graph 611 which displays emolytics data for a pre-specified time period (user selected).

Section 602 includes a map 612 which displays emolytics data for a pre-specified geographical region. For example, during a sports competition (e.g., a soccer game), the map 612 may display emolytics related to user's emotions, feelings, or perceptions during a pre-specified time period during the competition. Moreover, sections 603, 604 of dashboard 600 present additional emolytics data related to a specific context (e.g., the soccer game).

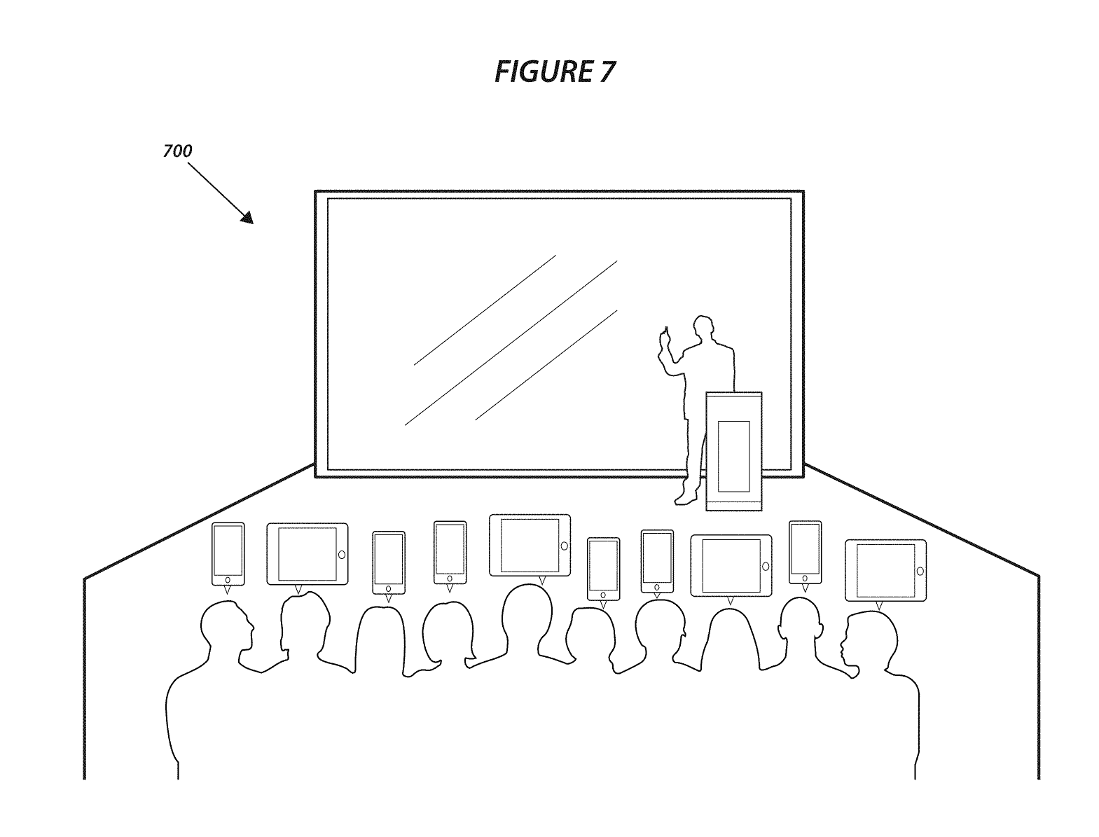

FIG. 7 is an illustration of a use case for employing emotion sensors during a live presentation. As shown in the figure, a plurality of users have computing devices (e.g., smartphones, tablets, desktop computers, laptop computers, etc.) to emote how they feel during the live presentation. In some implementations, the speaker has access to emolytics and may alternatively alter their presentation accordingly. For example, if the speaker determines from the emolytics that they are “losing their audience” based on a present low or a trending low emote signature, the speaker may in response choose to interject a joke, adlib, or skip to another section of the presenter's speech.

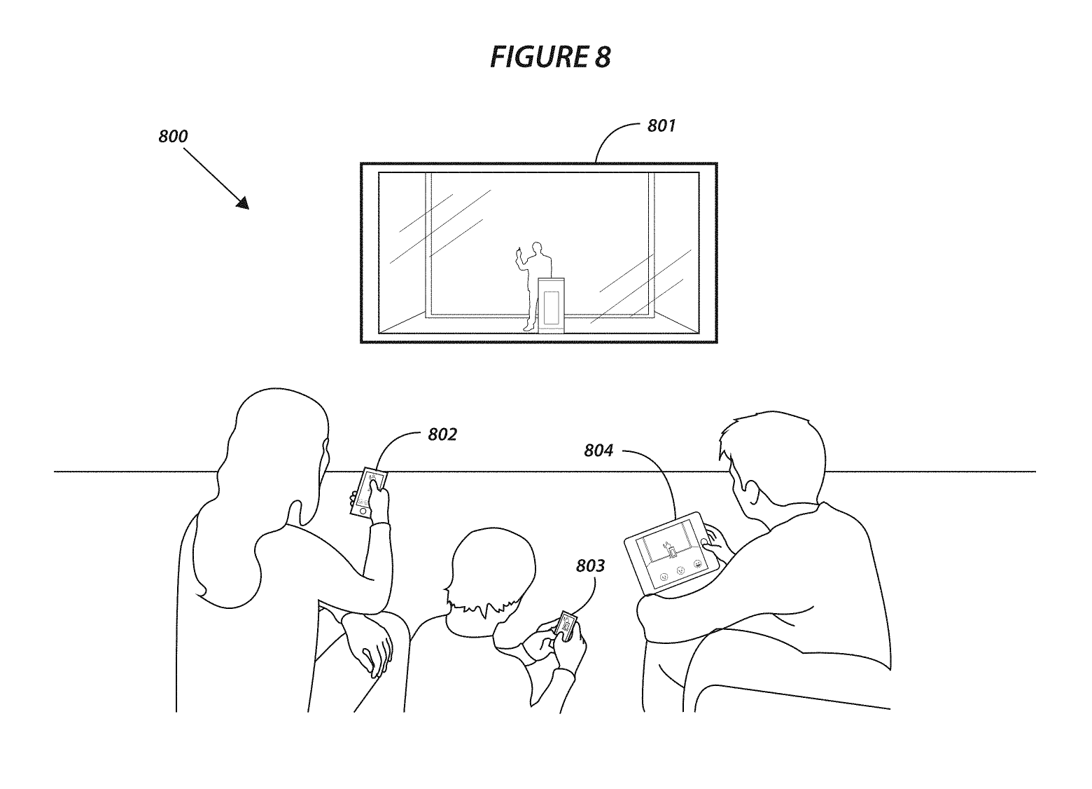

FIG. 8 is an illustration of another use case for employing emotion sensors for viewer's while watching a television show. The figure illustrates a family within their living room 800 emoting during the broadcast of a campaign speech. As each family member has access to a computing device, each member can emote to express their own personal emotions, feelings, perceptions, etc. in response to the campaign speech.

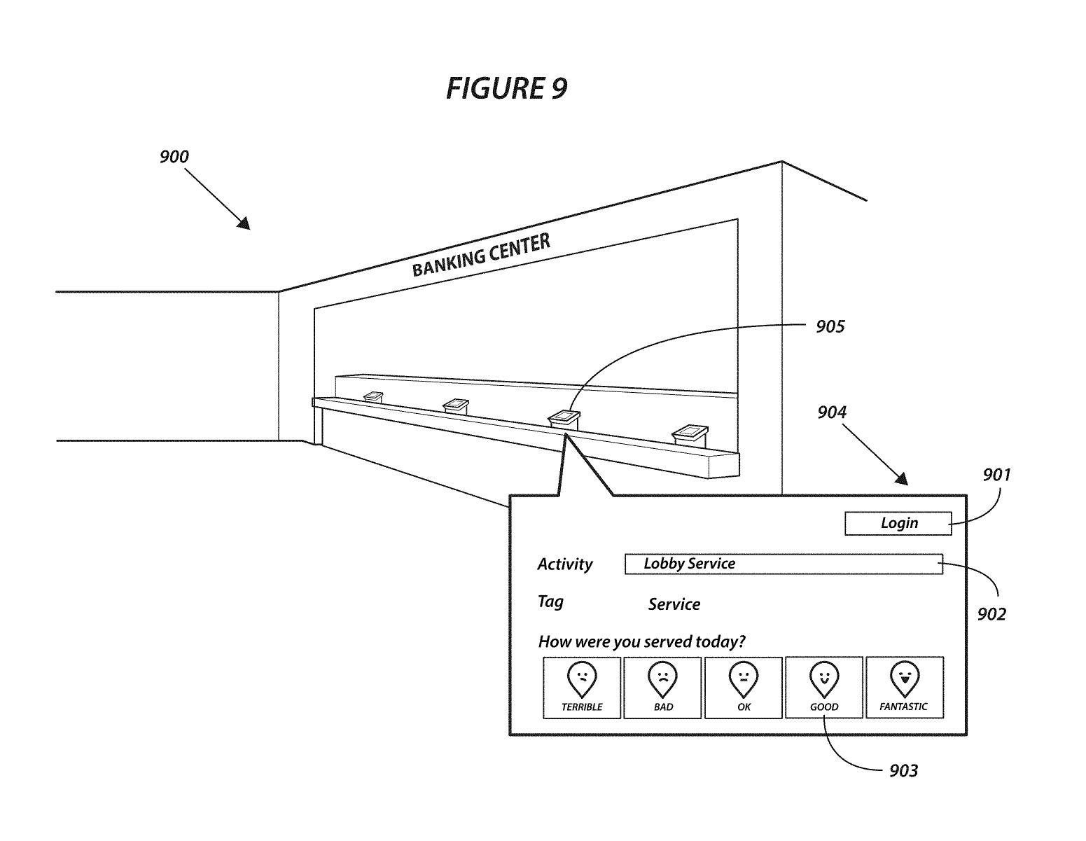

FIG. 9 is an illustration of yet another use case for employing emotion sensors within a customer service environment 900 (e.g., a banking center). Advantageously, customers can emote to give their feedback in response to the customer service that they received. For example, FIG. 9 illustrates a plurality of terminals 905 which prompt users to express how they feel in response to the customer service that they received. In the embodiment shown in the figure, customer service environment 900 is a banking center.

For example, once a user initiates a session provided by terminal 905, a user can rate their experience(s) by interacting with one or more emotion sensors 904 presented to the user during the session. The emotion sensor 904 may include a context label 902 and a plurality of emotives which provide users options to express their feelings about the customer service received. Users may choose to login 901 if they so choose during each session. In some embodiments, an emote record may be created during the session.

Emolytics data may be obtained for several geographic regions (e.g., states) such that service providers can tailor their service offerings to improve user feedback in needed areas.

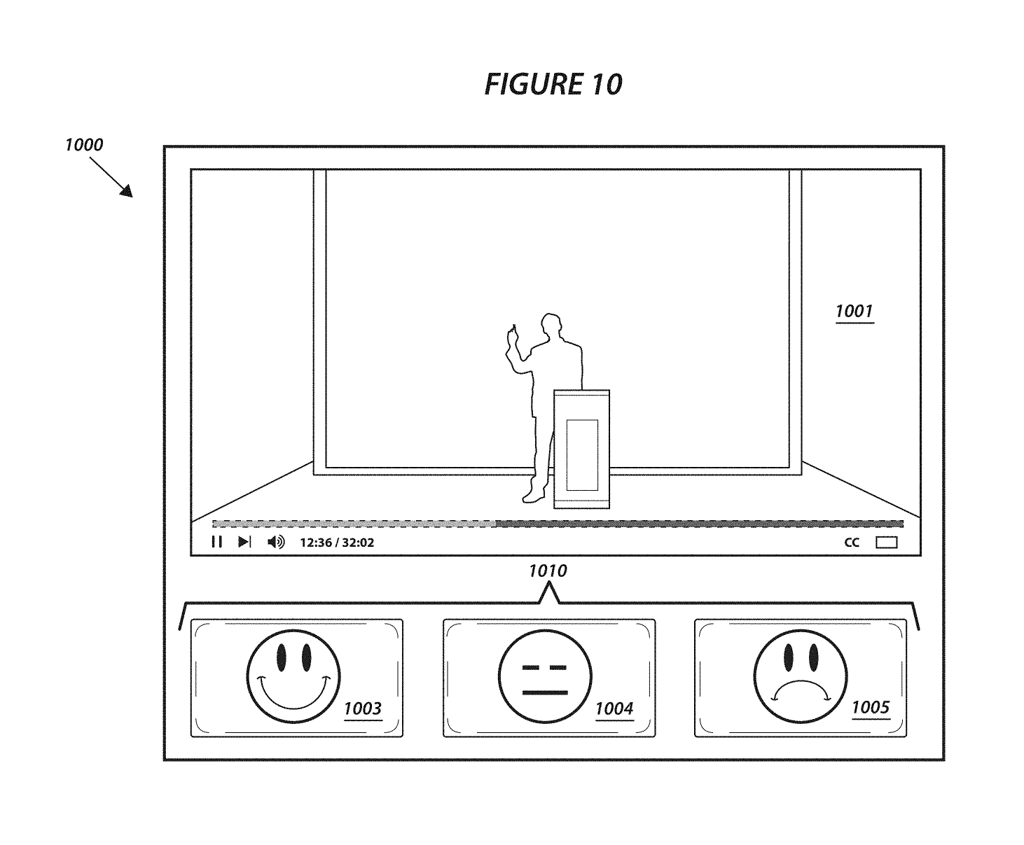

FIG. 10 is an illustration of an exemplary emotion sensor 1000 with an embedded video. Emotion sensor 1000 may be hosted on a website accessible by any of various computing devices (e.g., desktop computers, laptops, 2:1 devices, smartphones, etc.). In the embodiment shown, emotion sensor includes a media player 1001. Media player 1001 may be an audio player, video player, streaming video player, or multi-media player.

In one or more embodiments, emotion sensor 1000 includes an emoji palette 1000 having a plurality of emotives 1003-1005 which may be selected by users to express a present emotion that the user is feeling. For example, emotive 1003 expresses a happy emotion, emotive 1004 depicts a neutral emotion, and emotive 1005 depicts a sad emotion. Users may select any of these emotives to depict their present emotion during any point during the media's transmission.

For instance, if during the beginning of the media's transmission, users desire to indicate that they are experiencing a positive emotion, users can select emotive 1003 to indicate such. If, however, midway during the media's transmission, the users' desire to indicate that they are experiencing a negative emotion, users can select emotive 1005 to indicate this as well. Advantageously, users can express their emotions related to a context by selecting any one of the emotives 1003-1005, at any frequency, during the media's transmission.

It should be understood by one having ordinary skill in the art that the various types and number of emotives are not limited to that which is shown in FIG. 10. Moreover, emotion sensor 1000 may, alternatively, include an image or other subject matter instead of a media player 1000.

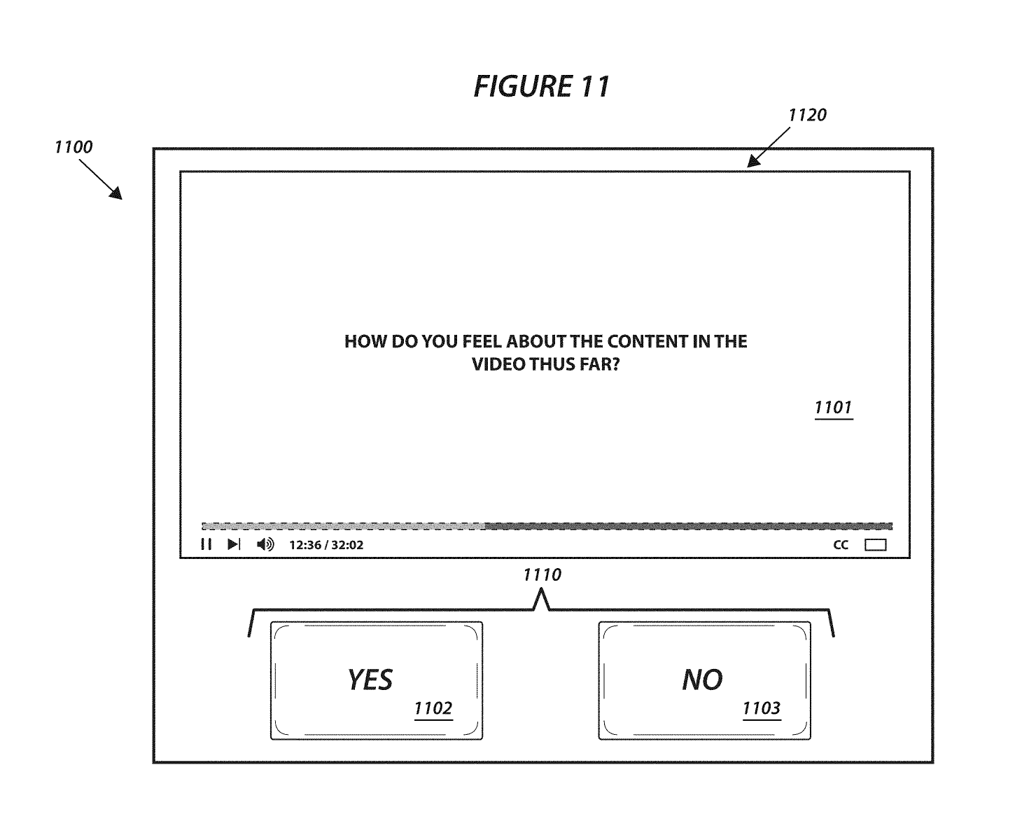

FIG. 11 is an illustration of another emotion sensor 1100 consistent with the present disclosure. Emotion sensor 1100 may also be hosted on a webpage assessable by a computing device. In some embodiments, emotion sensor 1100 includes a video image displayed on media player 1101. Emotion sensor 1100 may alternatively include a static image which users may emote in response thereto.

Notably, emotion sensor 1100 includes a palette of emote buttons 1110 with two options (buttons 1102, 1103) through which users can express “yes” or “no” in response to prompts presented by the media player 1101. Accordingly, an emote palette may not necessarily express users' emotions in each instance. It should be appreciated by one having ordinary skill in the art that emotion sensor 1100 may include more than the buttons 1102, 1103 displayed. For example, emotion sensor 1100 may include a “maybe” button (not shown) as well.

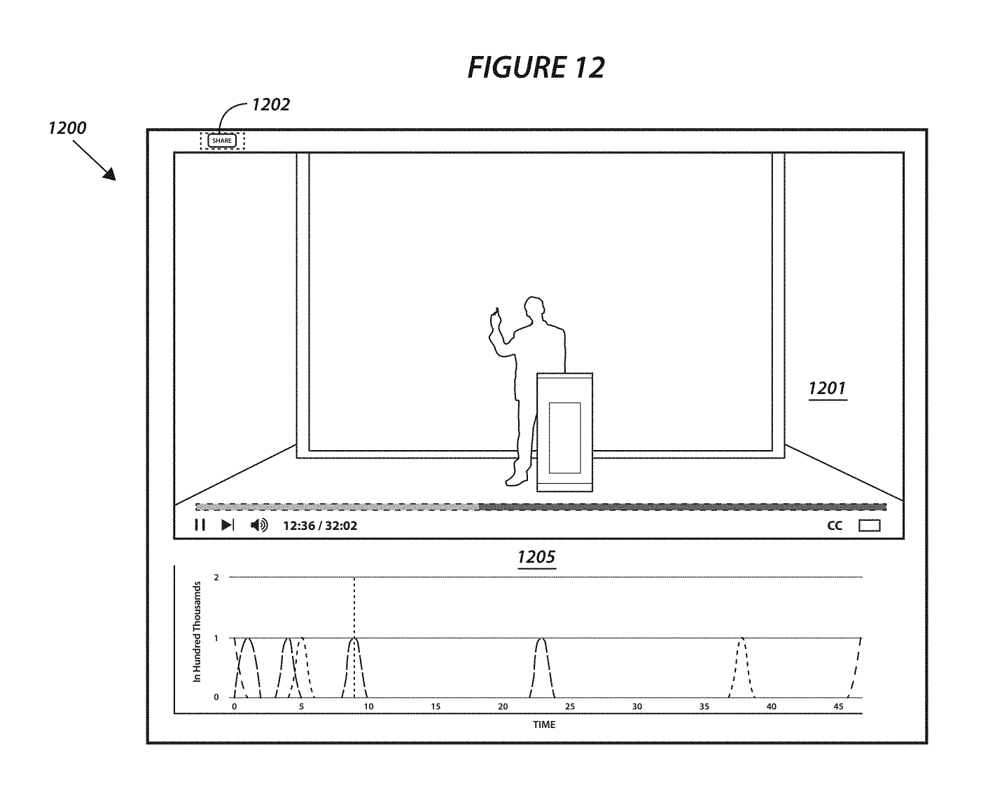

FIG. 12 is an illustration of yet another emotion sensor 1200 consistent with the present disclosure. Emotion sensor 1200 may also be hosted on a webpage assessable by a computing device. Notably, emotion sensor 1200 includes an analytics panel 1205 below the media, image, etc.

Analytics panel 1205 has a time axis (x-axis) and an emote count axis (y-axis) during a certain time period (e.g., during the media's transmission). Analytics panel 1205 may further include statistical data related to user emotes. Emotion sensor 1200 may also display a palette of emote buttons and the ability to share (1202) with other users.

Publishers or emoters may have access to various dashboards which displays one or more hyperlinks to analytics data which express a present idea or present emotion related to a context. In one embodiment, each of the hyperlinks include an address of a location which hosts the related analytics data.

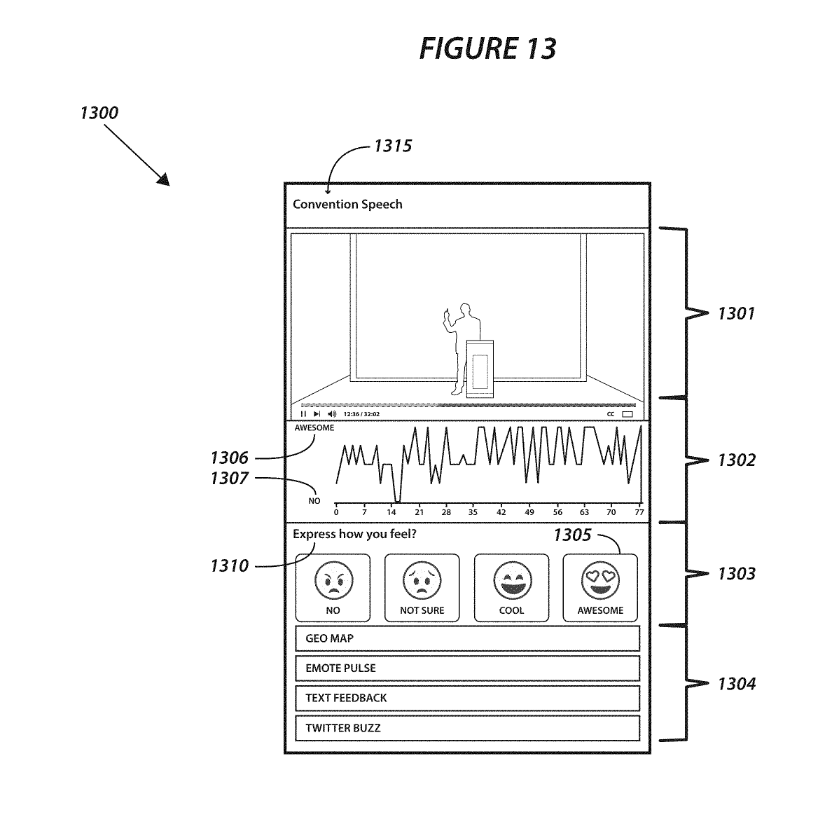

FIG. 13 is an illustration of a video emotion sensor 1300 used to gauge viewer emolytics during the broadcast of a convention speech. A title 1315 on the interface of the video sensor 1300 may define or may be related to the context. For example, if users emote while watching the broadcasted convention speech, analytics panel 1302 may display the average sentiment of emotes related to the televised political rally in real time. As user's emotions are expected to fluctuate from time to time, based on changes in stimuli (e.g., different segments of the convention speech), the data displayed on the analytics panel should likely fluctuate as well.

Notably, analytics panel 1302 displays the variance in users' sentiments as expressed by the emotives 1305 on the emoji palette 1303. For example, analytics panel 1302 displays that the aggregate mood/sentiment deviates between the “no” and “awesome” emotives. However, it should be understood by one having ordinary skill in the art that analytics panel 1302 by no way limits the present disclosure.

In one embodiment, emoji palette 1303 consists of emotives 1305 which visually depict a specific mood or sentiment (e.g., no, not sure, cool, and awesome). In one or more embodiments, a question 1310 is presented to the users (e.g., “Express how you feel?”). In some implementations, the question 1310 presented to the user is contextually related to the content displayed by the media player 1301.

Notably, video emotion sensor 1300 also comprises a plurality of other features 1304 (e.g., a geo map, an emote pulse, a text feedback, and a social media content stream) related to the context.

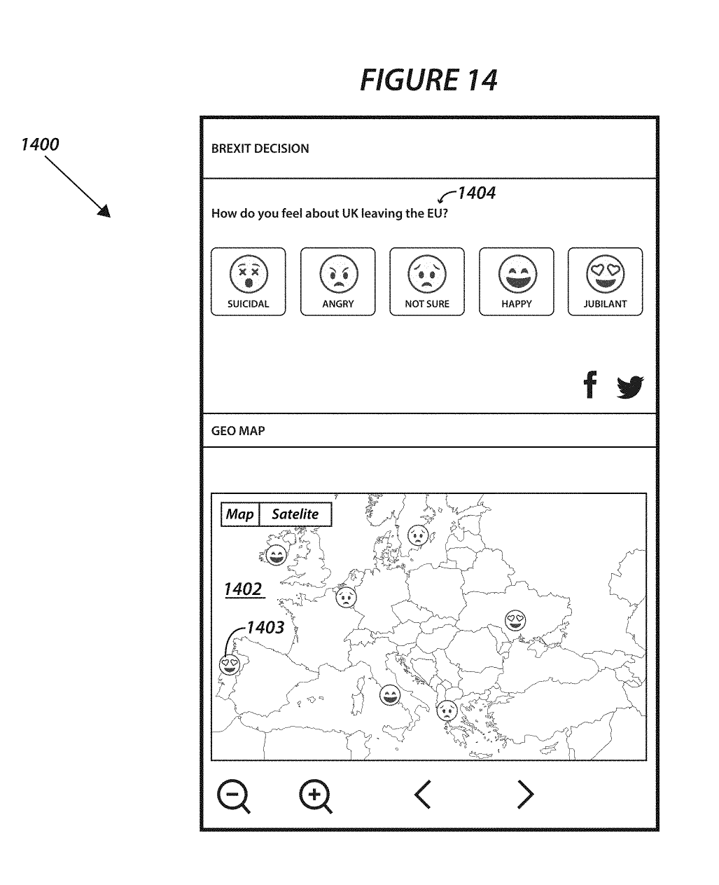

FIG. 14 is an illustration of a standard emotion sensor 1407 which features a geographical map 1402 (“geo map”) displaying a geographical distribution of emotion/sentiments related to a context. Geo map 1402 displays the location of a transmitted emote 1404, related to a context, at any given time. Alternatively, the emotes 1403 shown on the geo map 1402 represents the average (or other statistical metric) aggregate sentiment or mood of emoters in each respective location.

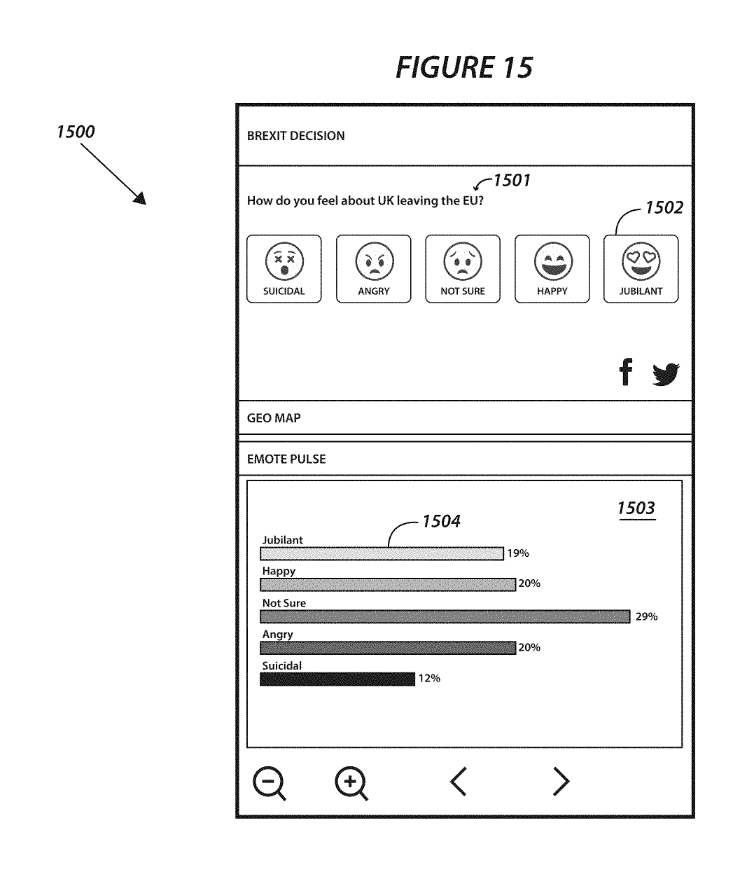

FIG. 15 is an illustration of a standard emotion sensor 1500 which features an emote related to a context. Emote pulse 1502 displays emolytics related to a context 1501. For example, in the example shown in the figure, 19% of users emoted that they felt jubilant about the UK leaving the EU, 20% felt happy, 29% felt unsure, 20% felt angry, and 12% felt suicidal about the UK's decision.

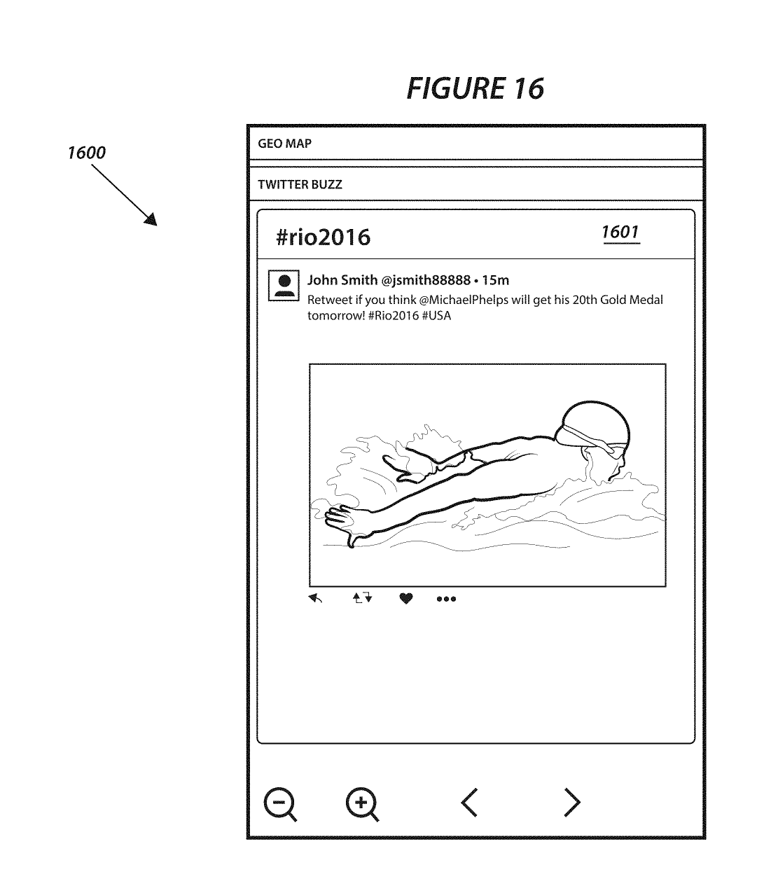

FIG. 16 is an illustration of a social media feed feature 1601 related to a context. Users can emote with respect to a context, obtain emolytics related to the context, and retrieve social media content (e.g., Twitter® tweets, Facebook® posts, Pinterest® data, Google Plus® data, or Youtube® data, etc.) related to the context.

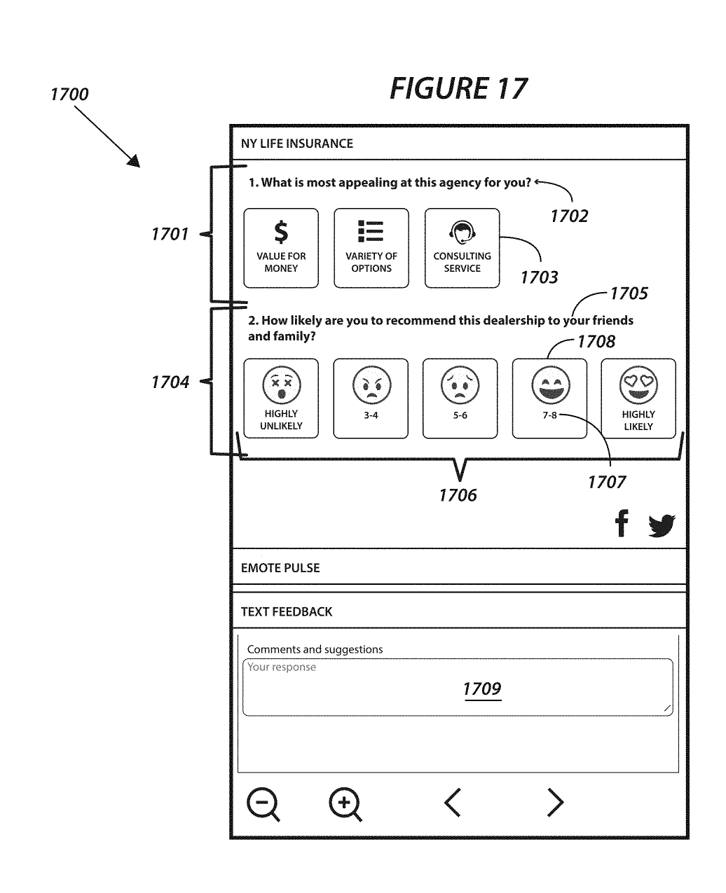

FIG. 17 is an illustration of a text feedback feature related to a context (e.g., NY Life Insurance). Emotion sensor's 1700 text feedback field 1709 may be used such that user's can submit feedback to publishers relating to the emotion sensor 1700. In addition, text feedback field 1709 may be used for users to express their feelings, sentiments, or perceptions in words that may complement their emotes. The emotion sensor 1700 includes two standard sensors—sensor 1702 (with context question 1702 and emotives 1703) and sensor 1704 (with context question 1705 and emotives 1708). Emotive 1708 of emoji palette 1706 may include an emoji which corresponds to a rating 1707 as shown in the figure.

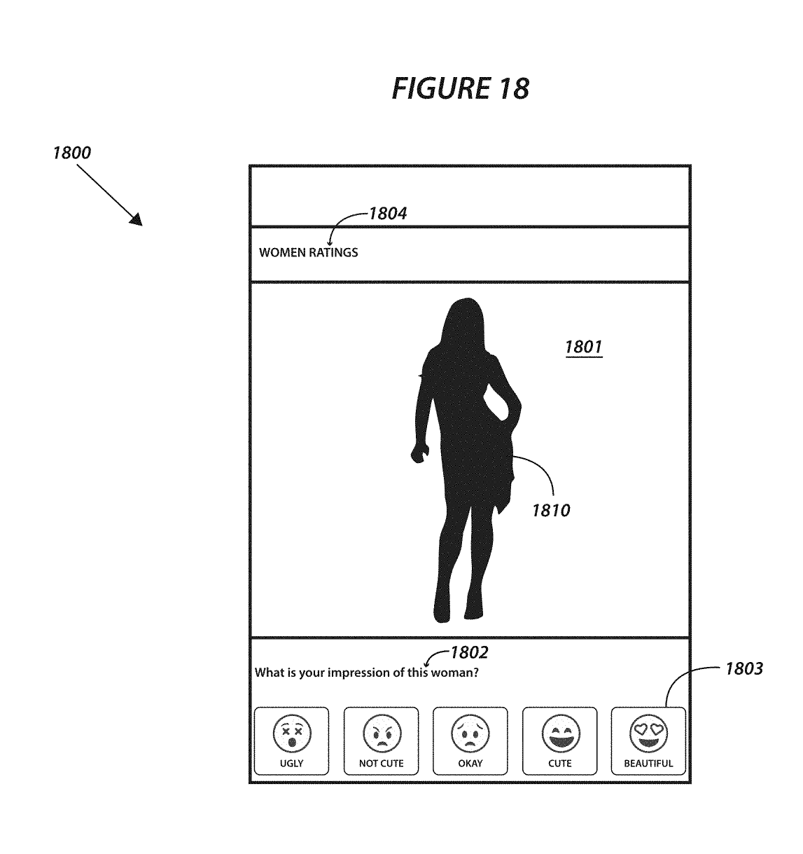

FIG. 18 is an illustration of an image emotion sensor 1800. In this embodiment, the context is the image 1801 displayed, the image emotion sensor 1800 may include a title 1804 that is related to the context (e.g., the displayed image 1801). Image emotion sensor 1800 depicts an image of a woman 1810 which users can emote to express their interest of or their perception of the woman's 1810 desirability.

Below the image 1801 is a context question 1802 which prompts a user to select any of the emojis 1803 displayed. The present disclosure is not limited to image emotion sensors 1800 which include static images. In some embodiments, image emotion sensor 1800 includes a graphics interchange format (GIF) image or other animated image which show different angles of the displayed image. In some embodiments, an image emotion sensor 1800 includes a widget that provides a 360 degree rotation function which may be beneficial for various applications.

For example, if an image emotion sensor 1800 includes an image 1801 of a house on the market, a 360 degree rotation feature may show each side of the house displayed such that users can emote their feelings/emotions/perceptions for each side of the home displayed in the image 1801.

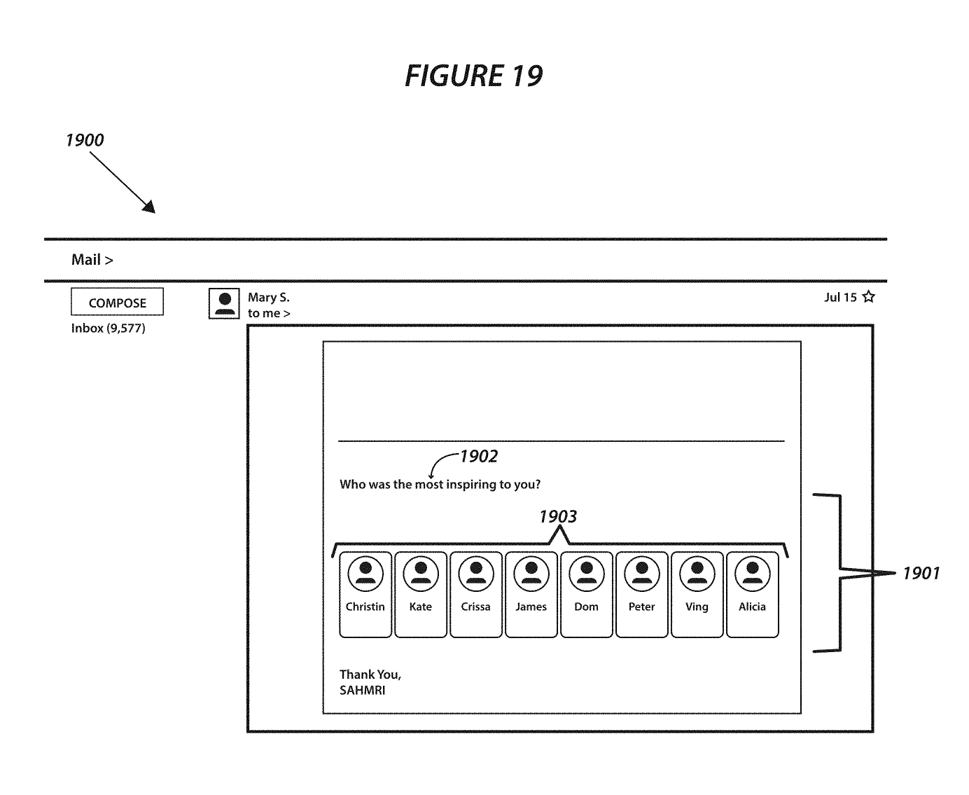

FIG. 19 is an illustration of an email emotion sensor 1901. As shown, email emotion sensor 1901 is embedded into an email 1900 and may be readily distributed to one or more individuals (e.g., on a distribution list). In the embodiment shown, email emotion sensor 1901 includes a context question 1902.

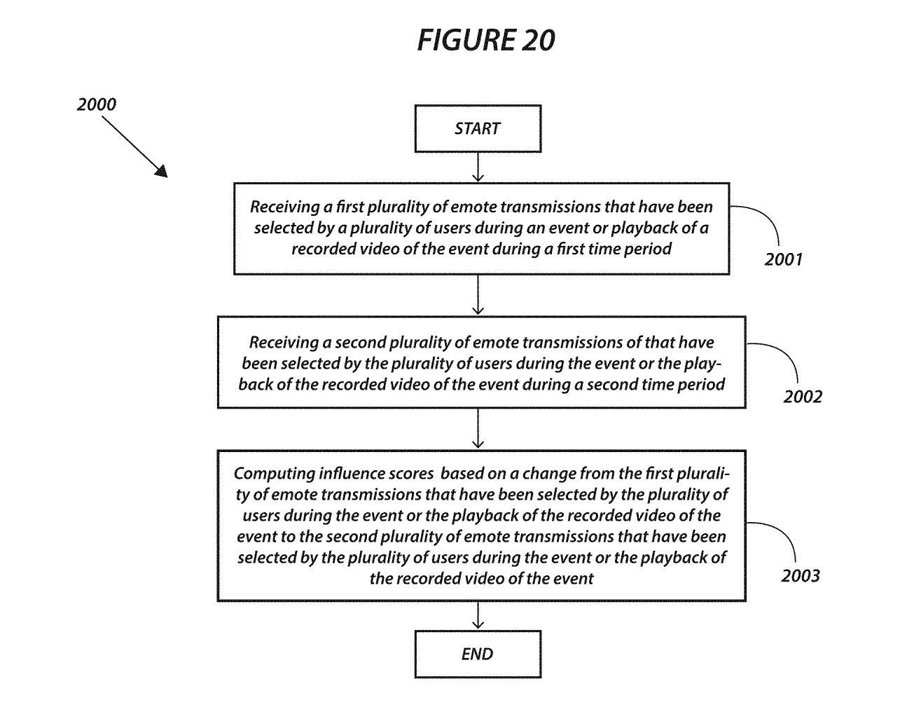

FIG. 20 is a flowchart 2000 for a method of computing influence scores within an emote system. Flowchart 2000 begins with block 2001—receiving a first plurality of emote transmissions that have been selected by a plurality of users during an event or playback of a recorded video of the event during a first time period. According to block 2001, a back-end server system (e.g., computer servers, etc.) receives user emotes during a concert, political rally/speech, campaign or other live event, or even during the transmission of a recorded video during a pre-determined time or interval. After the plurality of emote transmissions are received, the average or other statistical metric of the received emote transmissions may be determined.

Next, receiving a second plurality of emote transmissions that have been selected by a plurality of users during the event or playback of the recorded video of the event during a second time period. In one embodiment, the second time period is later than the first time period (block 2002). Once the second plurality of emote transmissions are received, the average or other statistical metric may be determined.

Next, according to block 2003, computing a score based on a change from the first plurality of emote transmission to the second plurality of emote transmissions. In one or more embodiments, the computed score is derived by comparing the mean (or other statistical metric) of the first plurality of emote transmissions to that of the second plurality of emote transmissions.

For example, in some embodiments, computing the score may comprise transforming the first and the second plurality of emote transmissions to a linear scale and aggregating the first and second plurality of emote transmissions by using a mathematical formula.

In some implementations, the computed scores are referred to as influence scores which express an amount of influence on the users (e.g., emoters) during the time elapsed between the first time period and the second time period.

In some implementations, the difference between the second time period and the first time period is the total time elapsed during the event or the recorded video of the event. Once the influence scores are computed, the scores may be transmitted to publishers, administrators, etc.

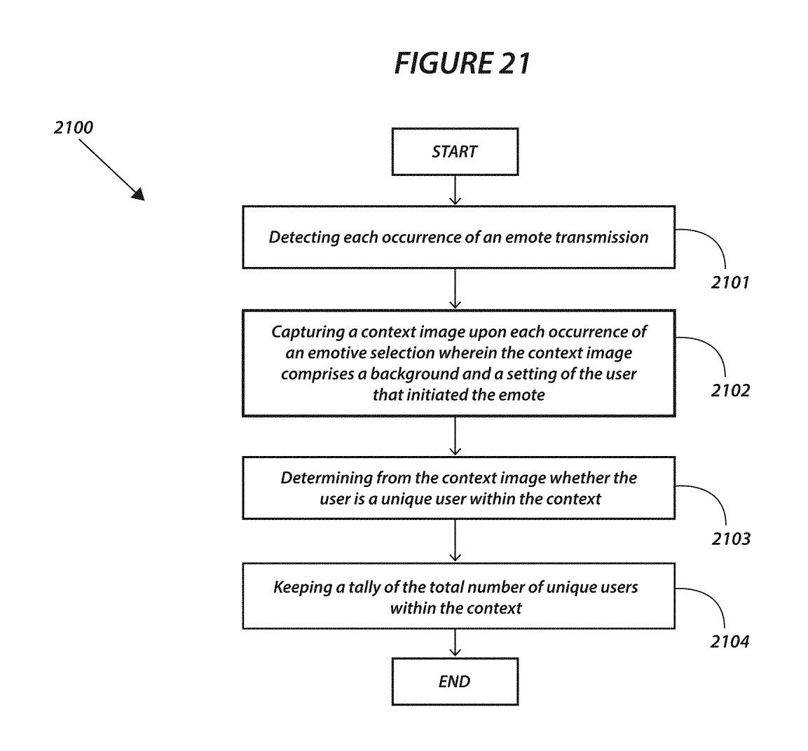

FIG. 21 is a flowchart 2100 for a method of tallying the number of unique individuals that use an emote system within a customer service environment.

First, detecting each occurrence of an emote transmission during an interaction with a context (block 2101).

Next, capturing a context image upon each occurrence of an emotive selection. In some embodiments, the context image comprises a background and a setting of the user that initiated the emote (block 2102).

In some implementations, a context image captured includes the upper body of the user that is presently responding to the context. For example, the context image may include the user's chest, shoulders, neck, or the shape of the user's head. In some implementations, the captured image does not include the facial likeness of the user (e.g., for privacy purposes). After the image is captured, recognition software may be employed to determine whether the image is a unique image.

Next, keeping a tally of the total number of unique users within the context (block 2104). The total number of unique users, along with their emotes, may be automatically sent or accessible to administrators.

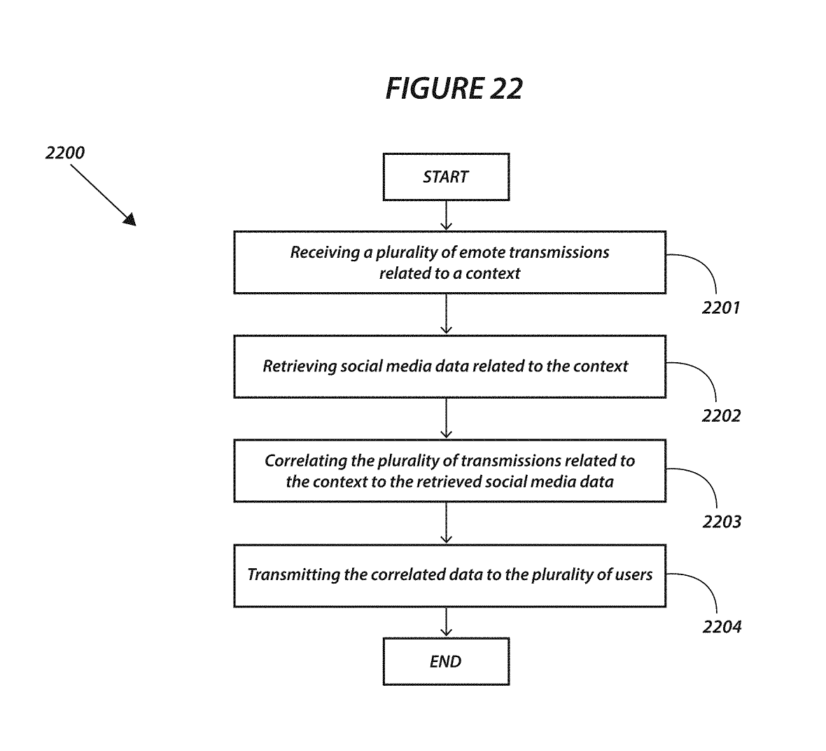

FIG. 22 is a flowchart 2200 for a method of correlating social media data with emotion data related to a context. Flowchart 2200 begins with block 2201—receiving a plurality of emote transmissions related to a context.

Next, retrieving social media data related to the context (block 2202). For example, Twitter® tweets may be retrieved related to a certain context using a Twitter® API or other suitable means.

Once the social media data is retrieved, this data is correlated with the emote data (block 2203). In some embodiments, a new pane may be integrated within a graphical user interface to display the social media data related to the context with the emotion data for a specific time period. A user can therefore view the emotion data and social media content related to a context in a sophisticated manner. The correlated data may provide contextualized trend and statistical data which includes data of social sentiment and mood related to a context.

Next, transmitting the correlated data to the plurality of users (2204). This correlated data may be transmitted or made accessible to users online, via a smartphone device, or any other suitable means known in the art.

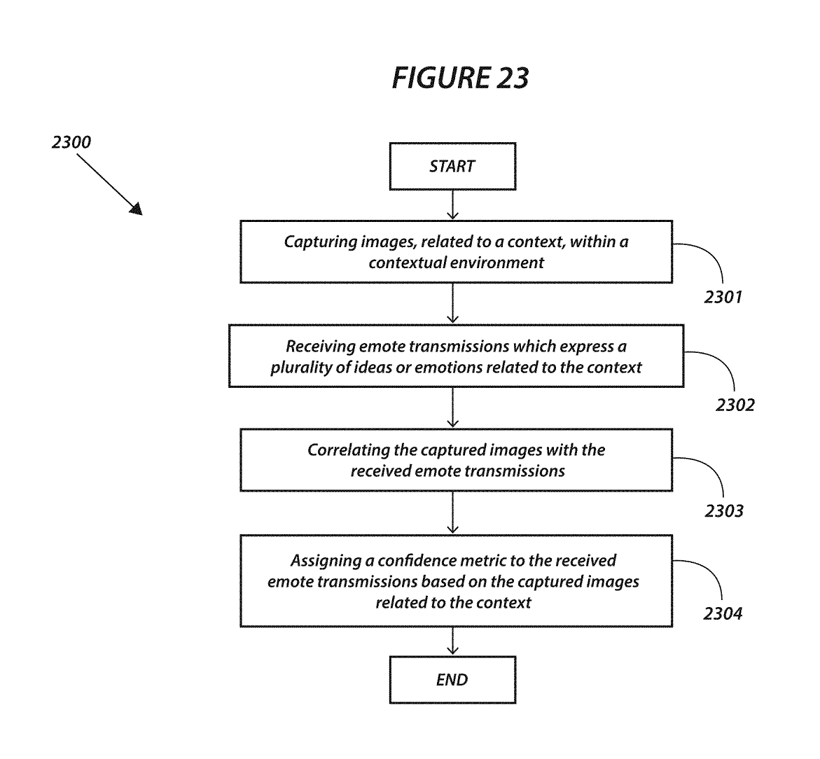

FIG. 23 is a flowchart 2300 for a method of computing a confidence metric assigned to emotion data related to a context. Flowchart 2300 begins with block 2301—capturing images, related to a context, within a contextual environment. In one or more embodiments, the images are captured by a camera placed within the contextual environment. The contextual environment may be any closed environment (e.g., a classroom, business office, auditorium, concert hall, or the like).

Next, receiving emote transmissions which express a plurality of ideas or emotions related to the context (block 2302). In one or more embodiments, a server or set of servers receive emote transmissions through a wireless communications network each time users select an emotive to express their emotions at any moment in time.

Block 2303—correlating the captured images with the received emote transmissions. For example, a software application may be used to determine the number of individuals within the contextualized environment. Once the number of individuals within the image is determined, this numer may be compared to the number of users that have emoted with respect to the context.

Block 2304—assigning a confidence metric to the received emote transmissions based on the captured images related to the context. In one or more embodiments, a confidence metric is assigned based on the ratio of emoters which have emoted based on the context and the number of individuals detected within the image.

For example, if the number of emoters related to the context is two but the number of individuals detected in the image is ten, a confidence level of 20% may be assigned based on this ratio. It should be understood by one having ordinary skill in the art that the present disclosure is not limited to an assigned confidence level that is a direct 1:1 relation to the computed ratio.

A method consistent with the present disclosure may be applicable to expressing emotes of one of various expected outcomes. First, receiving a plurality of emote transmissions related to a context during a first time period. The plurality of emote transmissions express various expected outcomes related to a context or expected outcomes of an activity to be executed during the event.

For example, if during a football game, when the team on offense is on their fourth down, users may be dynamically presented with an emote palette with icons of several offensive options (e.g., icons of a dive run play, field goal, pass play, or quarterback sneak).

In one or more embodiments, a winner (or winners) may be declared based on the actual outcome during a second time period (that is later in time than the first time period). The winners (or losers) may be sent a message, prize, advertisement, etc. according to a publisher's desire. The winner(s) may be declared within a pre-determined time frame, according to a pre-defined order, or by random selection.

Alternatively, after a last offensive play in a series (football game), an emote palette may be dynamically presented to users which feature emotives such that users can emote based on their present feelings, sentiment, etc. about the previous offensive play.

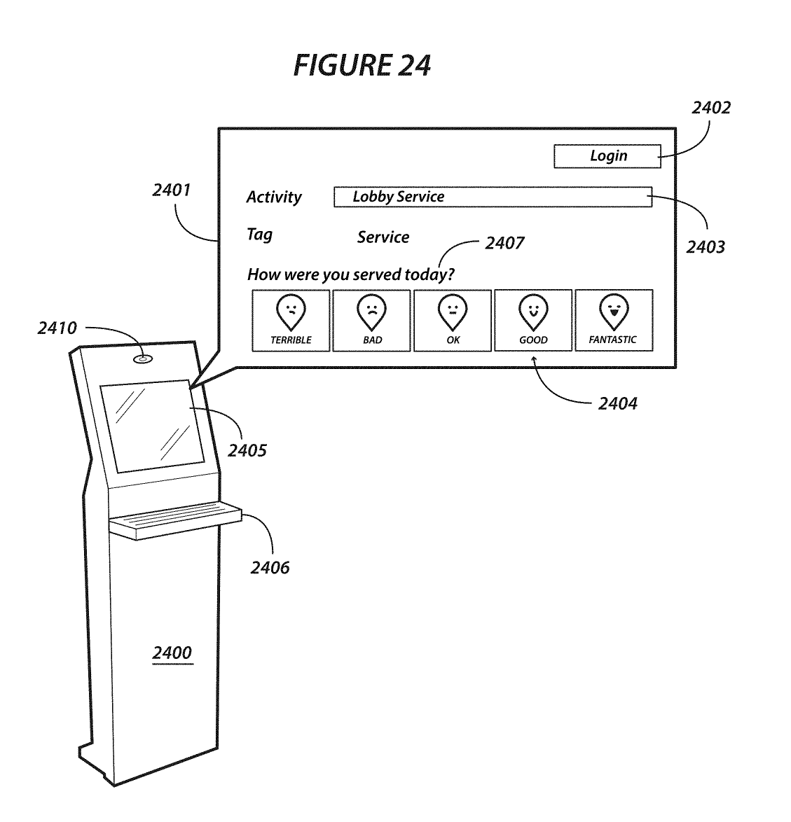

FIG. 24 is an exemplary kiosk system 2400 from which users can emote related to one or more contexts. Kiosk system 2400 may have features consistent with known kiosks such as a terminal with a display 2405 and a keyboard station 2406. Kiosk system 2400 may be employed within a customer service environment to retrieve information related to customer service experience(s).

Emotion sensor 2401 includes a context 2403 (i.e., lobby service), a context question 2407, and an emote palette 2404 (e.g., an emoji palette 2404). In addition, kiosk system 2400 includes a camera component 2410 which captures one or more contextual images while user's interact with the kiosk system 2400. Kiosk system 2400 (or other linked device/system) may determine from the contextual images whether the present user interacting with the kiosk system 2400 is a unique user.

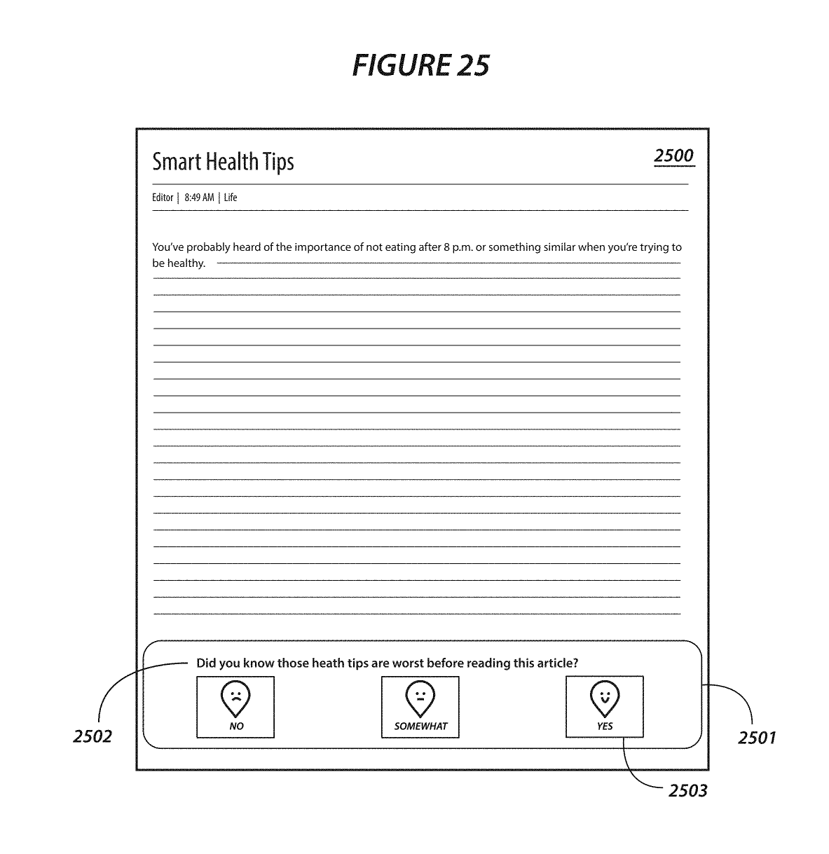

FIG. 25 is an exemplary webpage 2500 with a web-embedded emotion sensor 2501. Web-embedded emotion sensor 2501 may be incorporated within a webpage 2500 or any other medium with a HTML format by any suitable means known in the art. In the figure, web-embedded emotion sensor 2501 is positioned at the foot of the article hosted on webpage 2500. Web-embedded emotion sensor 2501 may include features such as, but not limited to, a context question 2502 and a palette of emojis 2503. In one implementation, the reader can express how they feel about an article (e.g., prompted by context question 2502) by emoting (i.e., selecting any one of the presented emotives 2503).

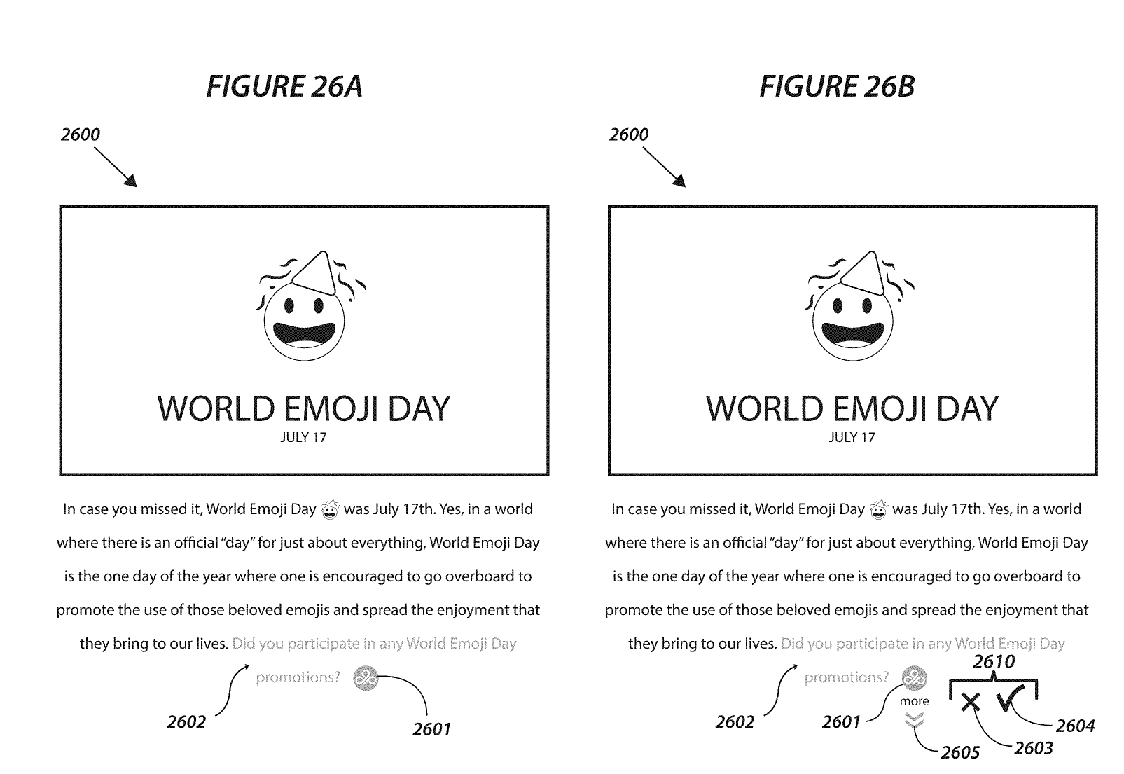

FIGS. 26A and 26B are illustrations of one embodiment of an emoji burst 2610. In particular, FIGS. 26A and 26B illustrate a web-embedded emotion sensor embedded into webpage 2600. As shown in the figure, key areas on the webpage 2600, a context question 2602 may be embedded to gauge a reader's feelings, perceptions, interests, etc. Most notably, a burst tab 2601 enables an emoji burst which gives users access to available emotive options.

In particular, emoji burst 2610 provides an affirmative indicator (i.e., check 2604) and a negative indicator (i.e., “X” 2603) option for emoters to choose in reference to the context question 2602. A feature 2605 gives users the ability to access additional options if available.

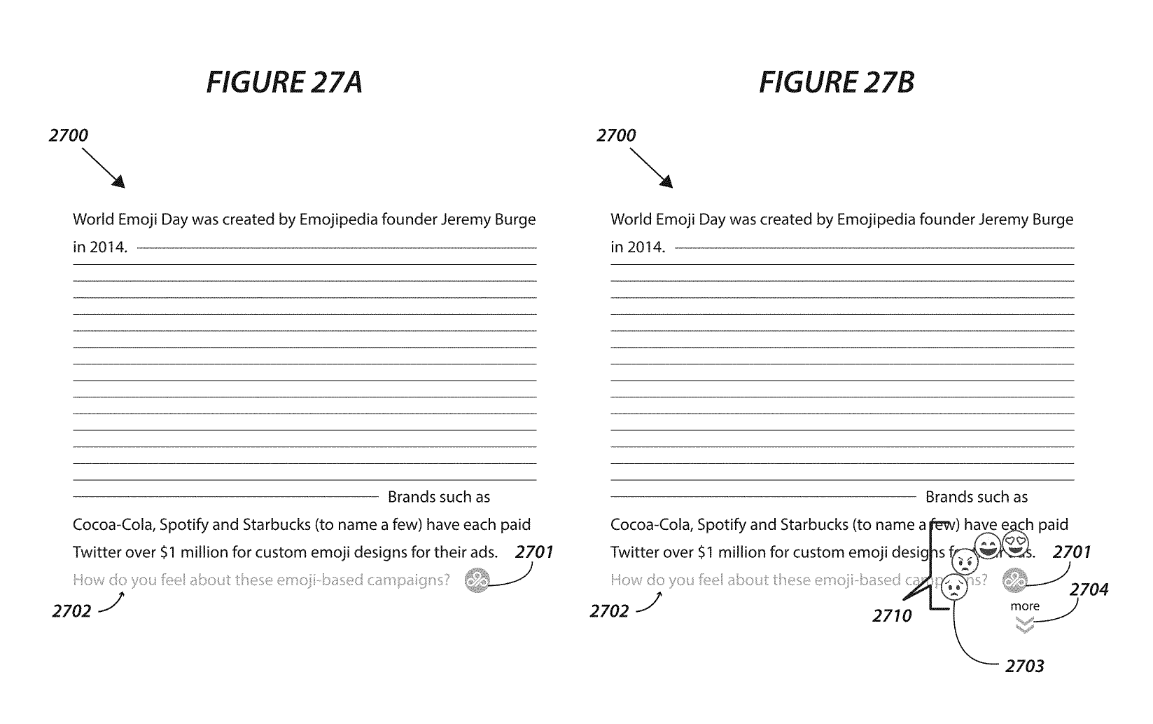

FIGS. 27A and 27B are illustrations of another embodiment of an emoji burst 2700. In particular, FIGS. 27A and 27B illustrate a web-embedded emotion sensor. A context question 2702 may be addressed by a reader by selecting the burst tab 2701. In the figure, emoji burst 2710 appears as an arc-distribution of emojis 2703. Feature 2704 allows a user to expand for additional options if available.

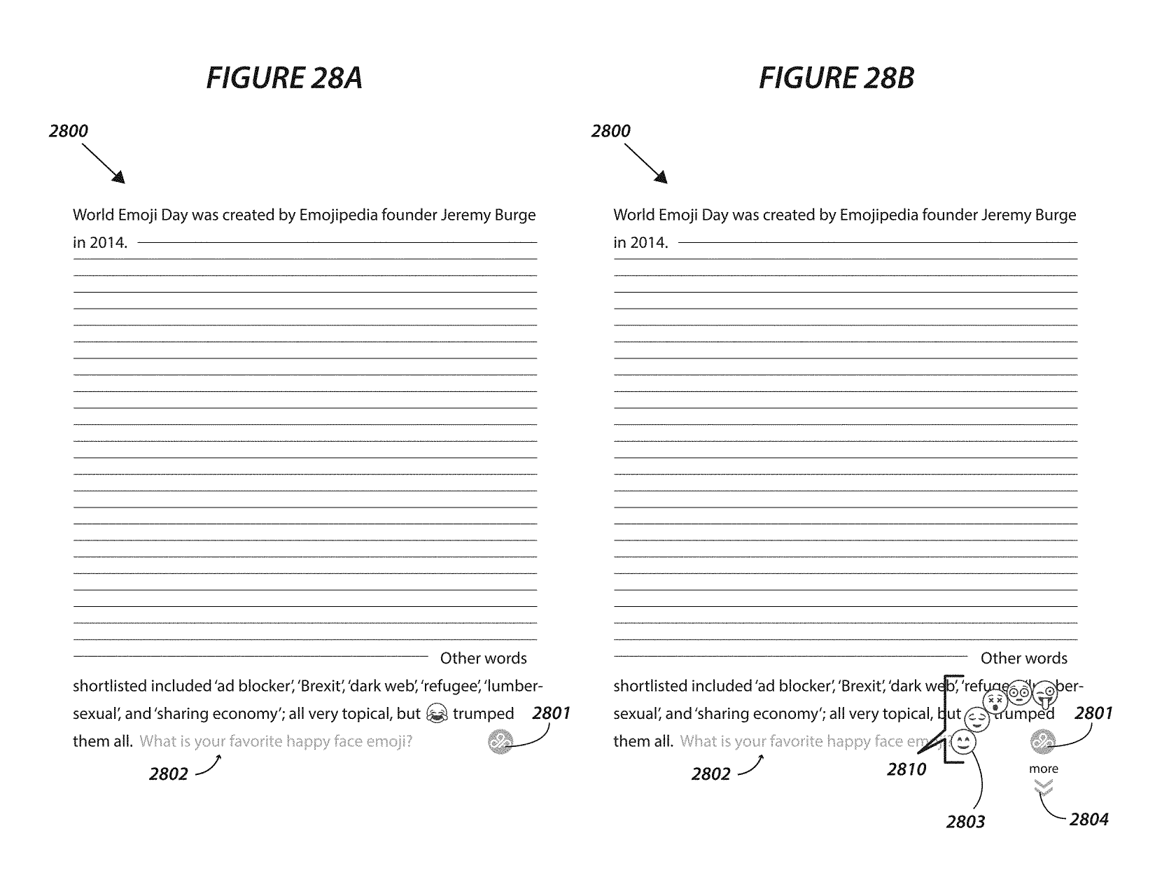

FIGS. 28A and 28B are illustrations of yet another embodiment of an emoji burst 2810. As shown, a web-embedded emotion sensor may be embedded into a webpage 2800. A context question 2802 may be addressed by a reader by selecting a burst tab 2801. In the figure, emoji burst 2810 appears as an arc-distributions of emojis 2803. The emojis featured in FIG. 28B represent a different emoji scheme than the emoji scheme shown in FIG. 27B.

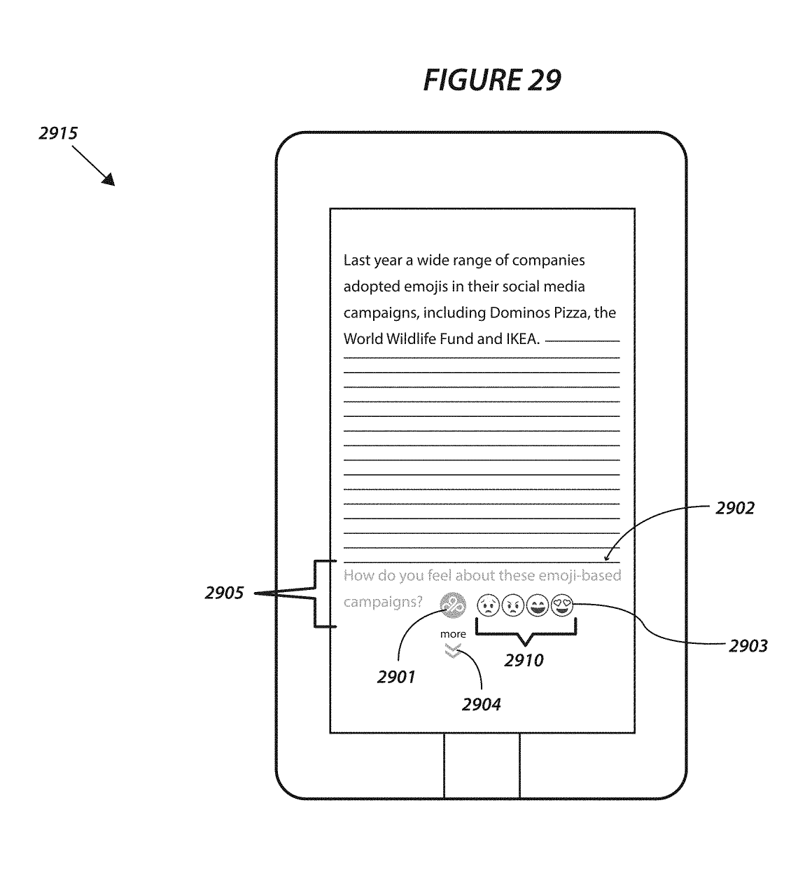

FIG. 29 is an illustration of an alternative layout of an emoji burst 2910 displayed on a tablet 2915. In particular, the emoji burst layout depicted in FIG. 29 may be employed by devices having displays with tight form factors (e.g., smartphones). Notably, a web-embedded emotion sensor 2905 may be embedded into webpage 2900.

A burst tab 2901 may be accessible near a context question 2902 and at the reader's discretion, the reader can emote using one or more emotives 2903 displayed (after “burst”) in a lateral fashion. Feature 2904 allows a user to expand for additional options if available.

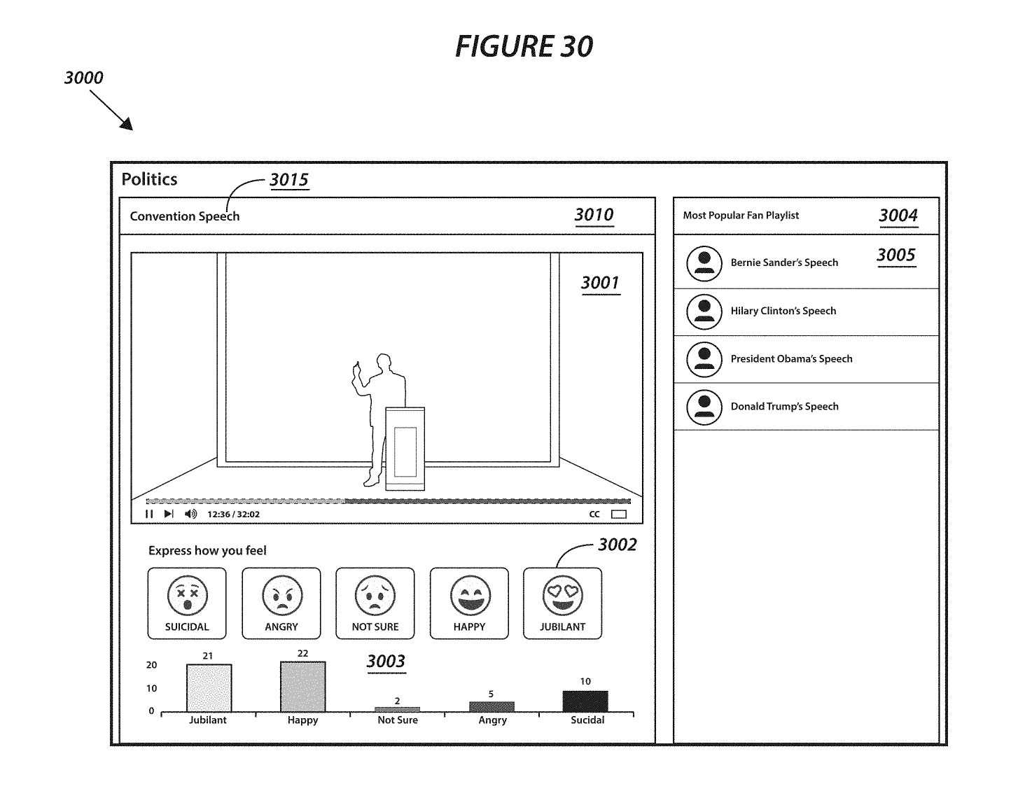

FIG. 30 is an illustration of a graphical user interface 3000 for a video emotion sensor 3010 related to a context 3015 and a playlist 3004 of video sensors related to the context. In the figure, context 3015 is that of a convention speech. As further shown, video emotion sensor 3010 includes a media player 3001 (e.g., video player), a palette of emotives 3002, and an analytics panel 3003. Playlist 3004 provides users with the option to choose other media (e.g., videos or images related to the context (e.g., track and field).

In one or more embodiments, graphical user interface 3000 includes a search function which allows users to search for video emotion sensors related to a particular context.

Systems and methods describing the present disclosure have been described. It will be understood that the descriptions of some embodiments of the present disclosure do not limit the various alternative, modified and equivalent embodiments which may be included within the spirit and scope of the present disclosure as defined by the appended claims. Furthermore, in the detailed description above, numerous specific details are set forth to provide an understanding of various embodiments of the present disclosure. However, some embodiments of the present disclosure may be practiced without these specific details. In other instances, well known methods, procedures, and components have not been described in detail so as not to unnecessarily obscure aspects of the present embodiments.

1. A non-transitory machine-readable storage medium containing instructions that, when executed, cause a machine to:
receive an indication that an icon has been selected by a user;
wherein a selected icon expresses at least one of a present idea or a present emotion in relation to a context;
wherein the indication is in response to sensing a segment of the context.

2. The non-transitory machine-readable storage medium of claim 1 further containing instructions that, when executed, cause a machine to transmit at least one response to the user in response to receiving the indication of the selected icon.

3. The non-transitory machine-readable storage medium of claim 2, wherein the at least one response is chosen at least in part based on indications of icons selected by other users.

4. The non-transitory machine-readable storage medium of claim 1 further containing instructions to receive a plurality of indications that a plurality of icons have been selected by a plurality of users in relation to the context.

5. The non-transitory machine-readable storage medium of claim 4 further containing instructions to transmit statistical data and metadata associated with the plurality of indications to the plurality of users.

6. The non-transitory machine-readable storage medium of claim 5, wherein the transmitted statistical data and metadata includes demographic data related to the plurality of users.

7. The non-transitory machine-readable storage medium of claim 3, wherein the at least one response is transmitted to a computing device of the user.

8. The non-transitory machine-readable storage medium of claim 7, wherein the computing device is at least one of a tablet, a smart phone, a desktop computer, or a laptop computer.

9. The non-transitory machine-readable storage medium of claim 1, wherein the selected icon is an emoji.

10. The non-transitory machine-readable storage medium of claim 1, wherein the selected icon is one of a plurality of emojis within a customized emoji scheme.

11. The non-transitory machine-readable storage medium of claim 10, wherein the indications of selected emojis are received during a live event.

12. The non-transitory machine-readable storage medium of claim 1, wherein the selected icon is one of a plurality of dynamically-displayed icons within a customized icon scheme.

13. The non-transitory machine-readable storage medium of claim 1, wherein the response is at least one of an image, an emoji, a video, or a uniform resource locator (URL).

14. A non-transitory machine-readable storage medium containing instructions that, when executed, cause a machine to:
receive a first plurality of indications of icons that have been selected by a plurality of users during a event or playback of a recorded video of the event during a first time period;
receive a second plurality of indications of icons that have been selected by a plurality of users during the event or the playback of the recorded video of the event during a second time period;
wherein the first and the second plurality of indications of icons express at least one of a plurality of present ideas or present emotions of the user;
wherein the second time period is later in time than the first time period; and
compute a score based on a change from the first plurality of indications of selected icons to the second plurality of indications of selected icons.

15. The non-transitory machine-readable storage medium of claim 14, wherein the score is an influence score which expresses an amount of influence on the users during the time elapsed between the first time period and the second time period.

16. The non-transitory machine-readable storage medium of claim 14, wherein computing the score comprises transforming the first and the second plurality of indications to a linear scale and aggregating the first and the second plurality of indications by using a mathematical formula.

17. The non-transitory machine-readable storage medium of claim 14, wherein the difference between the second time period and the first time period is the total time elapsed during the event.

18. The non-transitory machine-readable storage medium of claim 14, wherein the difference between the second time period and the first time period is the total time elapsed during the recorded video of the event.

19. The non-transitory machine-readable storage medium of claim 14, wherein the recorded video of the live event is displayed by a media player.

20. A non-transitory machine-readable storage medium containing instructions that, when executed, cause a machine to:
receive a plurality of indications of icons that have been selected by a plurality of users in relation to a context during a first time period;
wherein the plurality of indications of icons express at least one of a plurality of expected outcomes related to the context to be executed.

21. The non-transitory machine-readable storage medium of claim 20 further containing instructions that, when executed, cause a machine to declare at least one winner of the plurality of users based on the actual outcome during a second time period;
wherein the second time period is later in time than the first time period.

22. The non-transitory machine-readable storage medium of claim 21, wherein the one or more winners are transmitted a message.

23. A non-transitory machine-readable storage medium containing instructions that, when executed, cause a machine to:
receive a plurality of indications of icons that have been selected by a plurality of users during a event during a first time period;
wherein the plurality of indications of icons express at least one of a plurality of expected outcomes of an activity to be executed during the event.

24. The non-transitory machine-readable storage medium of claim 23 containing instructions further containing instructions that, when executed, cause a machine to declare at least one winner of the plurality of users based on the actual outcome during a second time period;
wherein the second time period is later in time than the first time period.

25. The non-transitory machine-readable storage medium of claim 23 further containing instructions to receive a plurality of indications of icons that have been selected by a plurality of users during a playback of a video recording of the event.

26. The non-transitory machine-readable storage medium of claim 23, wherein the event is a live sports game.

27. The non-transitory machine-readable storage medium of claim 23, wherein the event is of any competition which has an unknown outcome at some point in time.

28. The non-transitory machine-readable storage medium of claim 24, wherein one or more losers are transmitted a message.

29. The non-transitory machine-readable storage medium of claim 24, wherein one or more winners are transmitted a prize.

30. The non-transitory machine-readable storage medium of claim 23, wherein the icons comprise a “Yes” icon and a “No” icon.

31. The non-transitory machine-readable storage medium of claim 24, wherein the at least one winner is declared within a pre-determined time frame, according to a predefined order, or by a random selection.

32. The non-transitory machine-readable storage medium of claim 23, wherein the icons include one or more options associated with the expected outcome.

33. A non-transitory machine-readable storage medium containing instructions that, when executed, cause a machine to:
detect each occurrence of a selection of any of a plurality of icons during an interaction with a context;
capture an image upon each occurrence of an icon selection;
determine whether the image is a unique image; and
keep a tally of a total number of unique images.

34. The non-transitory machine-readable storage medium of claim 33, wherein the image depicts an human upper body.

35. The non-transitory machine-readable storage medium of claim 34, wherein the human upper body includes attributes that allows a software program determine whether the human upper body is associated with a unique user without determining the identity associated with the unique user.

36. The non-transitory machine-readable storage medium of claim 33, wherein to determine whether the image is a unique image comprises instructions to compare each image to a set of previously-captured unique images associated within the same context.

37. The non-transitory machine-readable storage medium of claim 33 further comprising instructions that, when executed, cause a machine to capture a context image upon each occurrence of an icon selection wherein a context image comprises a background and a setting.

38. A non-transitory machine-readable storage medium containing instructions that, when executed, cause a machine to:
receive a plurality of indications that any of several icons have been selected;
wherein each icon expresses a unique idea or a unique emotion in relation to a context;
retrieve social media data related to the context; and
generate correlated data by correlating the plurality of indications to the retrieved social media data.

39. The non-transitory machine-readable storage medium of claim 38 further containing instructions to transmit the correlated data to the plurality of users.

40. The non-transitory machine-readable storage medium of claim 38, wherein the retrieved social media data comprises at least one of Twitter® data, Facebook® data, Pinterest® data, Google Plus® data, or YouTube® data.

41. The non-transitory machine-readable storage medium of claim 38, wherein the correlated data provides contextualized trend and statistical data.

42. The non-transitory machine-readable storage medium of claim 41, wherein the contextualized trend and statistical data includes data related to social sentiment and mood.

43. A non-transitory machine-readable storage medium containing instructions that, when executed, cause a machine to:
retrieve data transmitted by users who are expressing emotions moment-by-moment through a customized emoji scheme;
wherein the data includes a first set of data captured during an event and a second set of data captured during a playback of the event.

44. The non-transitory machine-readable storage medium of claim 43 further containing instructions that, when executed, cause a machine to continuously update analytics information associated with the data.

45. The non-transitory machine-readable storage medium of claim 44 further containing instructions that, when executed, cause a machine to display the analytics information on an analytics panel within a dashboard.

46. The non-transitory machine-readable storage medium of claim 45, wherein the dashboard further incorporates a media player capable of transmitting a recording of the event.

47. The non-transitory machine readable storage medium of claim 43, wherein the playback of the event is a recorded video or a recorded audio.

48. A user interface, comprising:
a media player; and
one or more selectable icons that indicate one or more present ideas or present emotions for responding to content displayed by the media player.

49. The user interface of claim 48, wherein the user interface is a dashboard.

50. The user interface of claim 48, wherein the one or more selectable icons are located below the media player.

51. The user interface of claim 48 further comprising an analytics panel located below the media player.

52. The user interface of claim 51, wherein the analytics panel displays statistical data of the selected icons from a plurality of users.

53. The user interface of claim 48, wherein the media player is an audio player, a video player, or a multi-media player.

54. A system, comprising:
a kiosk, comprising:
a camera; and
a display, comprising:
a user interface having one or more icons that indicate one or more present ideas or present emotions; and
a non-transitory machine-readable storage medium comprising a back-end context recognition system.

55. The system of claim 54, wherein the camera is a front-facing camera.

56. The system of claim 54, wherein the kiosk is within a customer service environment.

57. The system of claim 56, wherein the customer service environment is at least one of a banking center, a hospitality center, or a healthcare facility.

58. The system of claim 54, wherein the back-end context recognition system captures images of human upper bodies associated with users.

59. The system of claim 58, wherein the back-end context recognition system compares each captured human upper body image with previously-captured human upper body images to determine a unique user.

60. A method, comprising:
capturing images, related to a context, within a pre-defined area;
receiving indications of selected icons which express a plurality of ideas or emotions related to the context; and
correlating the captured images with the received indications.

61. The method of claim 60 further comprising assigning a confidence metric to the received indications based on the captured images.

62. The method of claim 60, wherein the pre-defined area is one of a room, an auditorium, or a stadium.

63. The method of claim 60 further comprising correlating the captured images and the received indications with social media data related to the context.

64. The method of claim 60, wherein the images are captured by at least one camera disposed within the pre-defined area.

65. The method of claim 60, wherein the captured images depict the number of users that selected the icons within the pre-defined area in response to the context.

66. A non-transitory machine-readable storage medium containing instructions that, when executed, cause a machine to:
display an analytics panel with a first set of hyperlinks;
wherein each of the first set of hyperlinks include an address to analytics data, which express at least one of a present idea or present emotion, associated with a context.

67. The non-transitory machine-readable storage medium of claim 66 further containing instructions that, when executed, cause a machine to:
display a media player to present media associated with an associated context.

68. The non-transitory machine-readable storage medium of claim 66, wherein each of the first set of hyperlinks include an address of a location which hosts the associated analytics data.

69. The non-transitory machine-readable storage medium of claim 66, wherein the analytics panel includes a media player.

70. The non-transitory machine-readable storage medium of claim 66 further containing instructions that, when executed, cause a machine to present the first set of hyperlinks according to date, subject matter, or sentiment.

71. The non-transitory machine-readable storage medium of claim 66, wherein upon a selection of one of the first set of hyperlinks, display analytics data associated with the context.

72. The non-transitory machine-readable storage medium of claim 66 further containing instructions to display analytics data associated with the context.

73. The non-transitory machine-readable storage medium of claim 66, wherein the analytics panel includes an address to social media data associated with the context.

74. The non-transitory machine-readable storage medium of claim 66 further containing instructions that, when executed, cause a machine to display, on a user interface, a first set of hyperlinks to an analytics panel which displays one or more hyperlinks to analytics data, which express at least one of a present idea or present emotion, associated with a context.

75. The non-transitory machine-readable storage medium of claim 74, wherein the user interface is a graphical user interface.

76. The non-transitory machine-readable storage medium of claim 74 further containing instructions that, when executed, cause a media player to display media associated with a context.

77. The non-transitory machine-readable storage medium of claim 76, wherein the media player displays a streaming video associated with a context.

78. The non-transitory machine-readable storage medium of claim 74 further containing instructions that, when executed, cause a machine to display a search tool that allows a search to be executed for a particular context.

79. The non-transitory machine-readable storage medium of claim 74 further containing instructions that, when executed, cause a machine to display a second set of hyperlinks which include an address to social media data associated with the context.

80. The non-transitory machine-readable storage medium of claim 79 further containing instruction that, when executed, cause a panel to display the social media data, associated with the analytics panel, real time.
